(19) United States
(12) Patent Application Publication
(10) Pub. No.: US 2012/0082467 A1
(43) Pub. Date: Apr. 5, 2012

(54) OPTICAL TRANSMITTER, OPTICAL TRANSMISSION DEVICE, AND METHOD OF CONTROLLING OPTICAL TRANSMITTER

(75) Inventor: Kenichi NAKAMOTO, Kawasaki (JP)

(73) Assignee: FUJITSU OPTICAL COMPONENTS LIMITED, Kawasaki-shi (JP)

(21) Appl. No.: 13/247,471

(22) Filed: Sep. 28, 2011

(30) Foreign Application Priority Data
Oct. 1, 2010 (JP) 2010-223558

(51) Int. Cl. H04B 10/04

(52) U.S. Cl. 398/183

(57) ABSTRACT

An optical transmitter includes a driver outputting data; an optical modulator outputting an optical modulation signal by modulating light from a light source based on the data output from the driver; a detector detecting at least one of a signal intensity of the optical modulation signal from the optical modulator and a signal intensity of the data from the driver and outputs a detection result; and an adjustor adjusting a signal parameter of the data based on the detection result.

### CROSS-REFERENCE TO RELATED APPLICATIONS

This application is based upon and claims the benefit of priority of Japanese Patent Application No. 2010-223558, filed Oct. 1, 2010. The entire contents of which are incorporated herein by reference.

### FIELD

The embodiment discussed herein is related to an optical transmitter outputting an optical modulation signal by, for example, modulating light, an optical transmission device including the optical transmitter, and a method for controlling the optical transmitter.

### BACKGROUND

In a technical field of optical communications, optical modulators have been used. The optical modulator outputs an optical modulation signal by modulating light in accordance with data to be transmitted. To output the optical modulation signal, the optical modulators generally includes a light source, an optical modulator, and a driver. The light source outputs light. The optical modulator modulates the light. The driver supplies data to drive the optical modulator to obtain the optical modulation signal. For example, such an optical transmitter is used in an optical transmission device employing a WDM (Wavelength Division Multiplex) scheme using plural wavelength channels. Such an optical transmission device employing the WDM scheme may includes plural optical transmitters and an optical multiplexer. The plural optical transmitters output respective optical modulation signals having different wavelengths from each other. The optical multiplexer performs the wavelength-division multiplex on the optical modulation signals output from the plural optical transmitters, and outputs WDM signal light.
Patent Document 1: Japanese Laid-open Patent Publication No. 2008-141742.

A waveform of data to drive the optical modulator may be changed as temperature changes or as time elapses. Due to the change of the waveform, a duty ratio of the data may also be changed as temperature changes or as time elapses. Further, when a phase modulation scheme such as a DPSK (Differential Phase Shift Keying) modulation scheme is employed in the optical transmitter, due to the change of the duty ratio, jitters of the optical modulation signal may also be degraded. As a result, an OSNR (Optical Signal to Noise Ratio) may be degraded.

### SUMMARY

According to an aspect of the present invention, an optical transmitter includes a driver that outputs data; an optical modulator that outputs an optical modulation signal by modulating light from a light source based on the data output from the driver; a detector that detects at least one of a signal intensity of the optical modulation signal from the optical modulator and a signal intensity of the data from the driver and outputs a detection result; and an adjustor that adjusts a signal parameter of the data based on the detection result.

The object and advantages of the disclosure will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an example block diagram illustrating a configuration of an optical transmission system according to an embodiment of the present invention;

FIG. 2 is an example block diagram illustrating a configuration of an optical transmitter according to a first embodiment of the present invention;

FIG. 3 is an example flowchart illustrating an operational procedure of the optical transmitter according to the first embodiment of the present invention;

FIGS. 4A and 4B are graphs illustrating waveforms of a driver output signal, an optical modulation signal, an electrical spectrum of the optical modulation signal, and a demodulation signal obtained by demodulating the optical modulation signal when a duty ratio of the driver output signal is 100%;

FIGS. 5A to 5C are graphs illustrating waveforms of the driver output signal, the optical modulation signal, the electrical spectrum of the optical modulation signal, and the demodulation signal obtained by demodulating the optical modulation signal when the duty ratio of the driver output signal is less than 100%;

FIGS. 6A to 6C are graphs illustrating waveforms of the driver output signal, the optical modulation signal, the electrical spectrum of the optical modulation signal, and the demodulation signal obtained by demodulating the optical modulation signal when the duty ratio of the driver output signal is greater than 100%;

FIG. 7 is an example block diagram illustration a first modified example of the optical transmitter according to the first embodiment of the present invention;

FIG. 8 is an example block diagram illustration a second modified example of the optical transmitter according to the first embodiment of the present invention;

FIG. 9 is an example block diagram illustration a third modified example of the optical transmitter according to the first embodiment of the present invention;

FIG. 10 is an example block diagram illustrating a configuration of an optical transmitter according to a second embodiment of the present invention;

FIG. 11 is an example flowchart illustrating an operational procedure of the optical transmitter according to the second embodiment of the present invention;

FIGS. 12A and 12B are graphs illustrating waveforms of the driver output signal, the optical modulation signal, and an optical spectrum and the electrical spectrum of the optical modulation signal when the duty ratio of the driver output signal is 100%;

FIGS. 13A to 13D are graphs illustrating waveforms of the driver output signal, the optical modulation signal, and the optical spectrum and the electrical spectrum of the optical modulation signal when the duty ratio of the driver output signal is less than 100%;

FIGS. 14A to 14D are graphs illustrating waveforms of the driver output signal, the optical modulation signal, and the optical spectrum and the electrical spectrum of the optical modulation signal when the duty ratio of the driver output signal is greater than 100%;

FIG. 15 is an example block diagram illustrating a configuration of an optical transmitter according to a third embodiment of the present invention;

FIG. 16 is an example flowchart illustrating an operational procedure of the optical transmitter according to the third embodiment of the present invention;

FIG. 17 is an example block diagram illustration a first modified example of the optical transmitter according to the third embodiment of the present invention;

FIG. 18 is an example block diagram illustration a second modified example of the optical transmitter according to the third embodiment of the present invention;

FIG. 19 is an example block diagram illustration a third modified example of the optical transmitter according to the third embodiment of the present invention;

FIG. 20 is an example block diagram illustration a fourth modified example of the optical transmitter according to the third embodiment of the present invention;

FIG. 21 is an example block diagram illustration a fifth modified example of the optical transmitter according to the third embodiment of the present invention;

FIG. 22 is an example block diagram illustrating a configuration of an optical transmitter according to a fourth embodiment of the present invention;

FIG. 23 is an example flowchart illustrating an operational procedure of the optical transmitter according to the fourth embodiment of the present invention;

FIG. 24 is graphs illustrating waveforms of the driver output signal and the optical modulation signal when a duty ratio of the driver output signal is 100%;

FIGS. 25A and 25B are graphs illustrating waveforms of the driver output signal and the optical modulation signal when the duty ratio of the driver output signal is less than 100%;

FIGS. 26A and 26B are graphs illustrating waveforms of the driver output signal and the optical modulation signal when the duty ratio of the driver output signal is greater than 100%; and

FIG. 27 is an example block diagram illustration a first modified example of the optical transmitter according to the fourth embodiment of the present invention.

### DESCRIPTION OF EMBODIMENT

In the following, embodiments to carry out the present invention are described with reference to the accompanying drawings.

### (1) Optical Transmission System

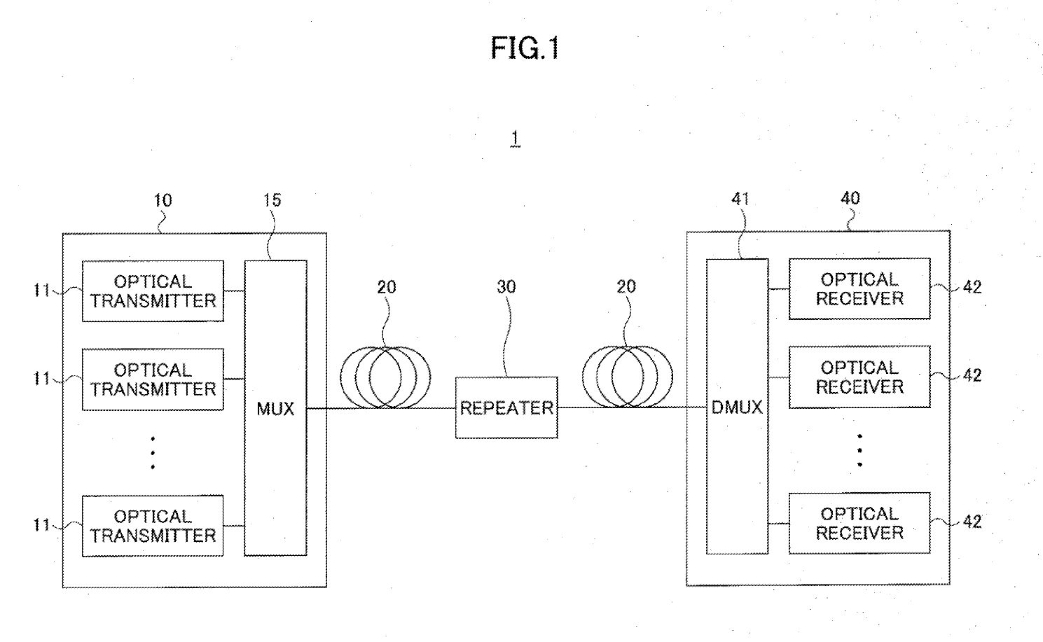

An optical transmission system 1 according to an embodiment of the present invention is described with reference to FIG. 1. FIG. 1 is an example block diagram of a configuration of the optical transmission system 1 according to an embodiment of the present invention.

As illustrated in FIG. 1, the optical transmission system 1 includes an optical transmission device 10, an optical fiber transmission path 20, and another optical transmission device 40. The optical transmission device 10 outputs a WDM (Wavelength Division Multiplex) optical signal. The optical fiber transmission path 20 is provided to transmit the WDM (Wavelength Division Multiplex) optical signal output from the optical transmission device 10. The optical transmission device 40 receives the WDM (Wavelength Division Multiplex) optical signal transmitted via the optical fiber transmission path 20.

The optical transmission device 10 includes plural optical transmitters 11 and an optical multiplexer (MUX) 15. The plural optical transmitters 11 are coupled to respective input ports of the optical multiplexer (MUX) 15. The output port of the optical multiplexer (MUX) 15 is coupled to the optical fiber transmission path 20. The optical multiplexer (MUX) 15 performs wavelength-division multiplex on plural optical modulation signals supplied from the respective optical transmitters 11, and outputs the WDM optical signal.

In the middle of the optical fiber transmission path 20, an optical repeater 30 is provided to compensate the attenuation of the WDM optical signal traveling in the optical fiber transmission path 20. The optical repeater 30 includes an optical amplifier to amplify the WDM optical signal. For example, the optical amplifier includes an optical amplifying medium (e.g., a doped fiber in which a rare-earth element is doped, and a semiconductor chip) and a pumping part to pump the optical amplifying medium so that the optical amplifying medium provides a gain band including a band of the WDM optical signal.

On the other hand, the optical transmission device 40 includes an optical demultiplexer (DMUX) 41 and plural optical receivers 42. The optical demultiplexer (DMUX) 41 separates (demultiplexes) the received WDM optical signal into plural optical modulation signals of the respective channels. The plural optical receivers 42 receive the respective separated optical modulation signals.

Instead of the optical transmission device 10 outputting the WDM optical signal, an optical transmission device 10 outputting optical modulation signals from the optical transmitters 11 without performing the wavelength-division multiplex may be used. In this case, the optical transmission device 10 may not include the optical multiplexer (MUX) 15. Further, the optical transmission device 10 may not include two or more optical transmitters 11. In the same manner, Instead of the optical transmission device 40 receiving the WDM optical signal, an optical transmission device 40 receiving an optical modulation signal that has not been wavelength-division multiplexed. In this case, the optical transmission device 40 may not include the optical demultiplexer (DMUX) 41. Further, the optical transmission device 40 may not include the two or more optical receivers 42.

### (2) Optical Transmitter According to a First Embodiment of the Present Invention

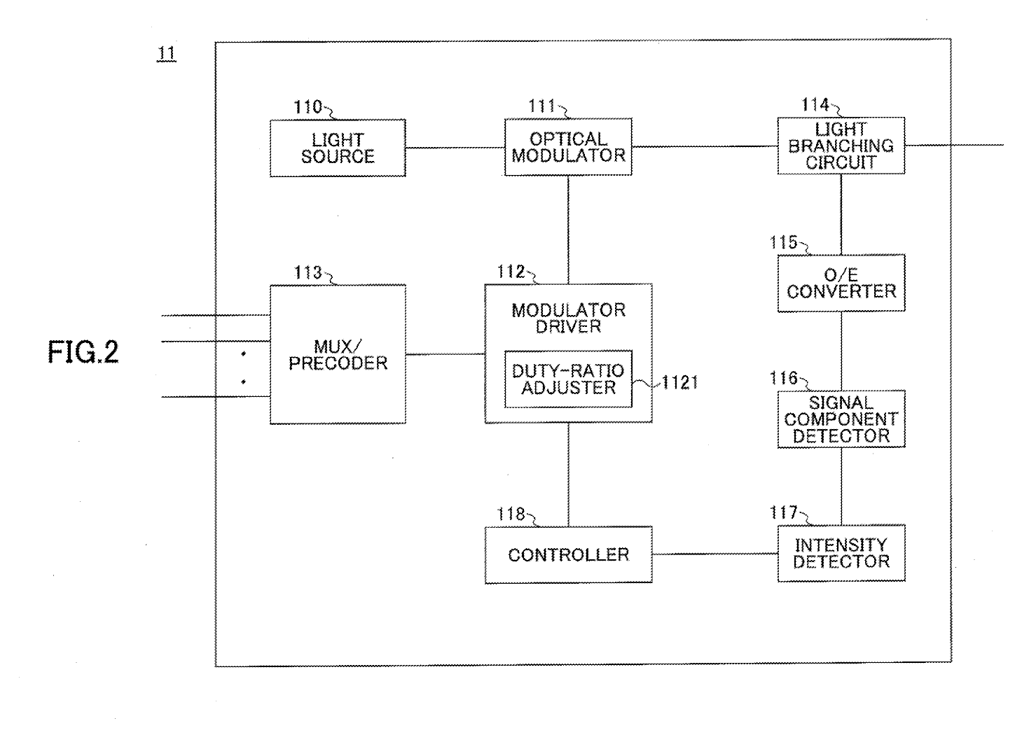

An optical transmitter 11 according to the first embodiment of the present invention is described with reference to FIGS. 2 to 6.

### (2-1) Configuration of Optical Transmitter According to the First Embodiment of the Present Invention

An example configuration of the optical transmitter 11 according to the first embodiment of the present invention is described with reference to FIG. 2. FIG. 2 is an example block diagram of a configuration of the optical transmitter 11 according to the first embodiment of the present invention.

As illustrated in FIG. 2, the optical transmitter 11 includes a light source 110, a optical modulator 111, a modulator driver 112, an MUX (Multiplexer)/precoder 113, a light branching circuit 114, an O/E (Optical/Electronic) converter 115, a signal component detector 116, an intensity detector 117, and a controller 118.

The light source 110 outputs light having a desired wavelength. The light output from the light source 110 is incident into the optical modulator 111. As an example of the light source 110, a tunable laser diode may be used.

The optical modulator 111 modulates the light from the light source 110 based on a driver output signal output from the modulator driver 112. In this first embodiment, it is preferable that the optical modulator 111 employs a DPSK (Differential Phase Shift Keying) modulation scheme or any other phase modulation scheme as an optical modulation scheme. However, the optical modulator 111 may employ any other modulation scheme as the optical modulation scheme. As a result, the optical modulator 111 outputs modulated light as the optical modulation signal.

As an example of the optical modulator 111, a Mach-Zehnder-type optical modulator may be used. The Mach Zehnder type optical modulator is typically formed on a substrate including a pair of Mach-Zehnder-type optical waveguides and electrodes corresponding to the pair of Mach-Zehnder-type optical waveguides. Further, the Mach-Zehnder-type optical waveguides and the relevant electrodes have an electro-optical effect of lithium niobate (LN) or the like. In this case, when the driver output signal is applied to the electrode, light incident into one terminal of the Mach-Zehnder-type optical waveguide is modulated. Further, in addition to the driver output signal, a bias voltage to adjust a driving point of the optical modulator 111 may also be applied to the electrode. As a result, a modulated light (i.e., the optical modulation signal) is output from the other terminal from the other terminal of the Mach-Zehnder-type optical waveguide.

The modulator driver 112 generates the driver output signal to drive the optical modulator 111 (i.e., to cause the optical modulator 111 to modulate light) in accordance with a modulation signal output from the MUX/precoder 113. The modulator driver 112 outputs the generated driver output signal to the optical modulator 111. The modulator driver 112 is one example of a “driver”.

The modulator driver 112 includes a duty-ratio adjuster 1121. For example, the duty-ratio adjuster 1121 and the controller 118 constitute an “adjuster”. The duty-ratio adjuster 1121 adjusts a duty ratio of the driver output signal under control of the controller 118. Herein, the duty ratio may refer to a ratio between a signal component of the data where the signal intensity is equal to or greater than the predetermined value and a signal component of the data where the signal intensity is less than the predetermined value.

The MUX/precoder 113 generates a data signal having a high bit rate (e.g., tens of Gbps) by multiplying plural data signals having a low bit rate (e.g., several hundreds of Mbps) supplied from outside of the optical transmitter 11. In addition, the MUX/precoder 113 generates a modulation signal in accordance with the data signal having the high bit rate. For example, the MUX/precoder 113 generates a modulation signal in accordance with the data signal by performing an encoding process reflecting difference information between a one bit previous code and the current code using the data signal having a high bit rate. The MUX/precoder 113 outputs the generated modulation signal to the modulator driver 112.

The light branching circuit 114 branches the light output from the optical modulator 111 (i.e., the optical modulation signal). As a result, the light branching circuit 114 outputs the light output from the optical modulator 111 (i.e., the optical modulation signal) to the O/E converter 115 and outside of the optical transmitter 11 as well.

The O/E converter 115 converts the light output from the light branching circuit 114 (i.e., the optical modulation signal) into an electric signal. The O/E converter 115 outputs the electric signal to the signal component detector 116. In this case, in light of a fact that a frequency component (“f0 component”) corresponding to the bit rate of the optical modulation signal (i.e., the bit rate of the data signal multiplexed by the MUX/precoder 113) is detected by the signal component detector 116 described in detail below, it is preferable that the electric signal converted from the optical modulation signal includes the f0 component. Specifically, for example, it is preferable that the O/E converter 115 is a photo detector having a band where the f0 component can be detected.

The signal component detector 116 detects the frequency component (“f0 component”) corresponding to the bit rate of the optical modulation signal (i.e., the bit rate of the data signal multiplexed by the MUX/precoder 113) from the electric signal converted from the optical modulation signal. To that end, the signal component detector 116 may include a band pass filter having characteristics to pass the frequency component of the narrow band corresponding to the f0 component and having a high Q-value as well. The signal component detector 116 outputs the detected f0 component to the intensity detector 117.

Herein, the term “frequency component (“f0 component”) corresponding to the bit rate” may refer to a frequency component that corresponds to the bit rate or a frequency component substantially corresponding to the bit rate when a predetermined margin is considered. In this case, for example, when the bit rate is “X(bps)”, the “frequency component (“f0 component”) corresponding to the bit rate” may be “X(Hz)” or “H±α(Hz)”.

The intensity detector 117 detects signal intensity (e.g., average signal intensity) of the f0 component corresponding to the bit rate. To that end, the intensity detector 117 may include a low pass filter passing a frequency component sufficiently lower than the f0 component. The intensity detector 117 outputs the detected signal intensity of the f0 component to the controller 118.

The controller 118 adjusts the duty ratio of the driver output signal in accordance with the signal intensity of the f0 component detected by the intensity detector 117. More specifically, for example, the controller 118 adjusts the duty ratio of the driver output signal so as to maximize the signal intensity of the f0 component. Further, the controller 118 adjusts the duty ratio of the driver output signal by controlling the operation of the duty-ratio adjuster 1121. The controller 118 may be, for example, a processor such as a CPU (Central Processing Unit).

### (2-2) Operations of Optical Transmitter According to the First Embodiment of the Present Invention

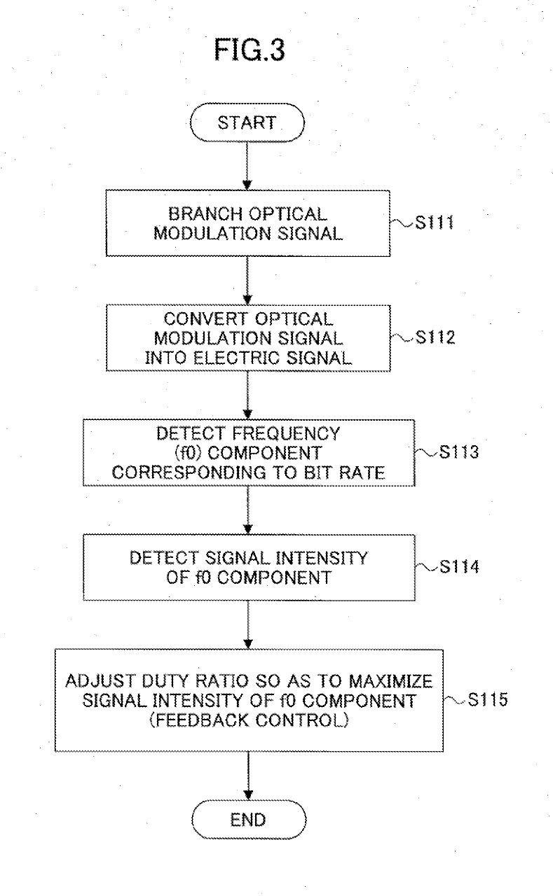

Operations of the optical transmitter 11 according to the first embodiment of the present invention are described with reference to FIG. 3. FIG. 3 is an example flowchart illustrating an operational procedure of the optical transmitter 11 according to the first embodiment of the present invention. Further, in the following, the description is focused on an adjusting operation of adjusting the duty ratio of the driver output signal from among the operations of the optical transmitter 11 according to the first embodiment of the present invention.

As illustrated in FIG. 3, the light branching circuit 114 branches the optical modulation signal output from the optical modulator 111 (operation S111). The light branching circuit 114 outputs the branched optical modulation signal to the O/E converter 115. The O/E converter 115 converts the optical modulation signal into an electric signal (operation S112). Next, the O/E converter 115 outputs the electric signal to the signal component detector 116.

Then, the signal component detector 116 detects the frequency component (f0 component) corresponding to the bit rate of the optical modulation signal (operation S113). The signal component detector 116 outputs the detected f0 component to the intensity detector 117. Then, the intensity detector 117 detects the signal intensity of the f0 component corresponding to the bit rate (operation S114). The intensity detector 117 outputs the detected signal intensity of the f0 component to the controller 118.

Then, the controller 118 adjusts the duty ratio of the driver output signal so as to maximize the signal intensity of the f0 component detected by the intensity detector 117 (operation S115). Specifically, for example, the controller 118 adjusts the duty ratio of the driver output signal in a manner such that the signal intensity of the f0 component after the adjustment of the duty ratio is greater than the signal intensity of the f0 component before the adjustment of the duty ratio (i.e., the signal intensity of f0 component detected by the intensity detector 117).

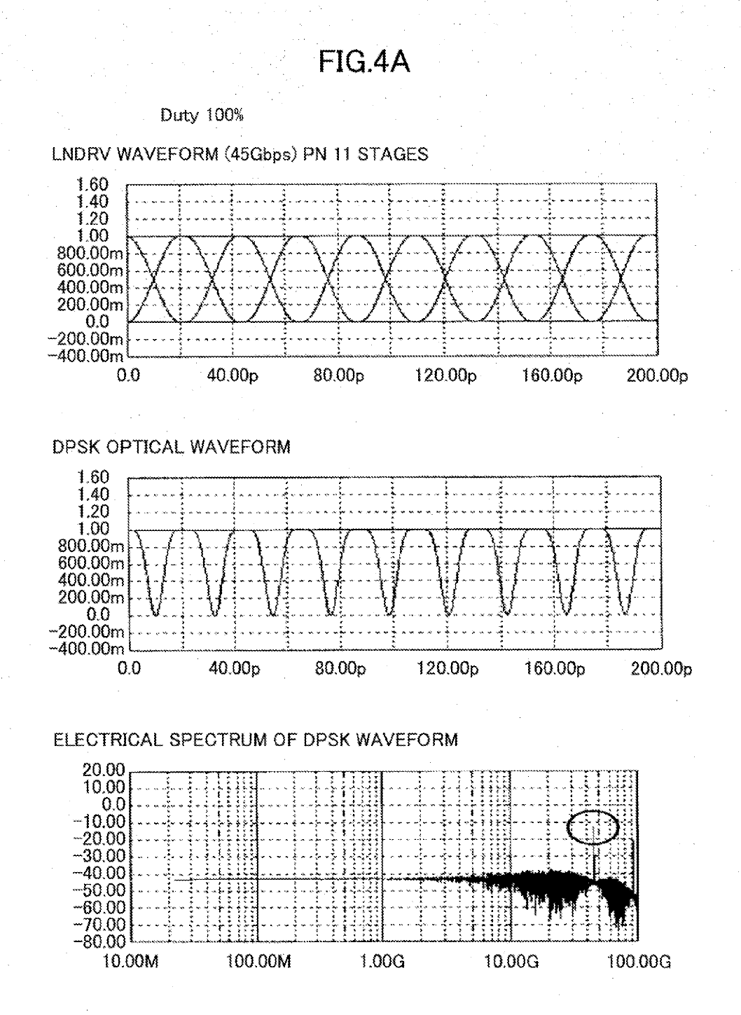

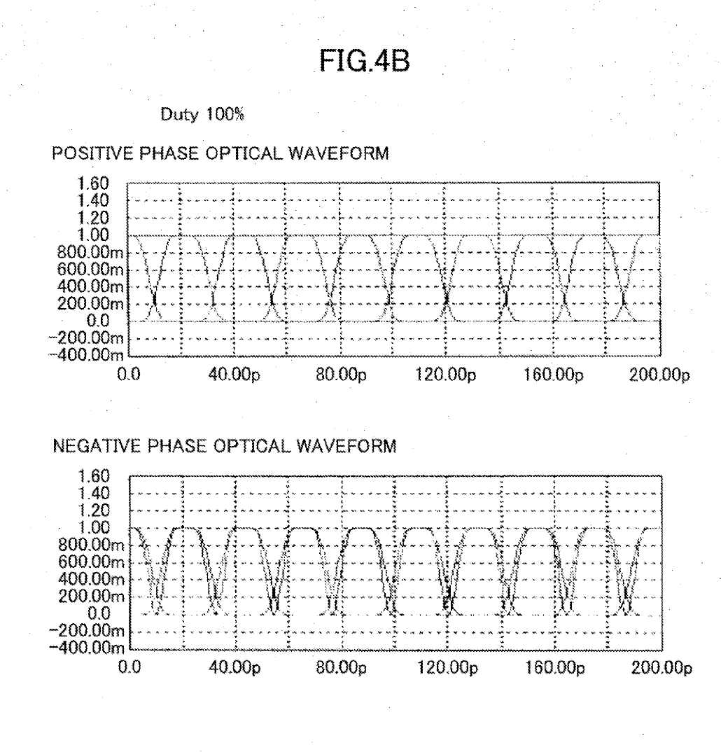

Herein, a technical meaning of the adjustment of the duty ratio of the driver output signal so as to maximize the signal intensity of the f0 component corresponding to the bit rate is described with reference to FIGS. 4 to 6. FIGS. 4 to 6 are graphs illustrating waveforms of the driver output signal, the optical modulation signal, an electrical spectrum of the optical modulation signal, a demodulation signal obtained by demodulating the optical modulation signal when a duty ratio of the driver output signal is changed.

FIGS. 4A and 4B illustrate the waveform of the driver output signal (LNDRV waveform 45 Gbps), the waveform of the optical modulation signal (DPSK optical waveform), the electrical spectrum of the optical modulation signal, and the waveforms of the demodulation signal (positive optical waveform and negative optical waveform) when the duty ratio of the driver output signal is 100%. Herein, it is assumed that FIGS. 4 to 6 illustrate a case where the bit rate of the optical modulation signal is 45 Gbps. Therefore, in this case, the f0 component corresponding to the bit rate is a frequency component of 45 GHz.

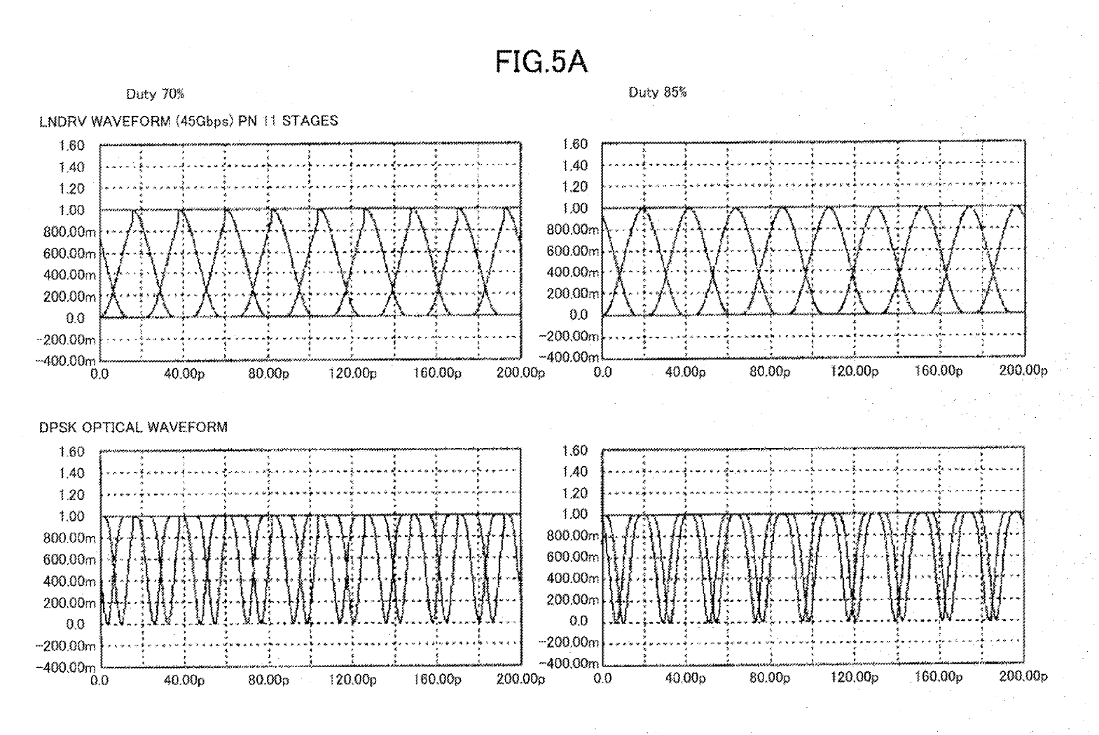

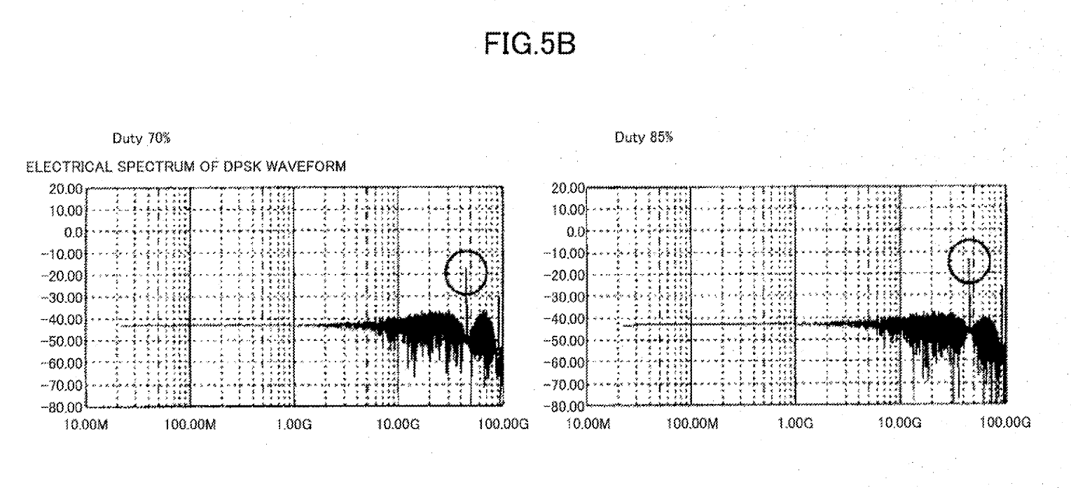

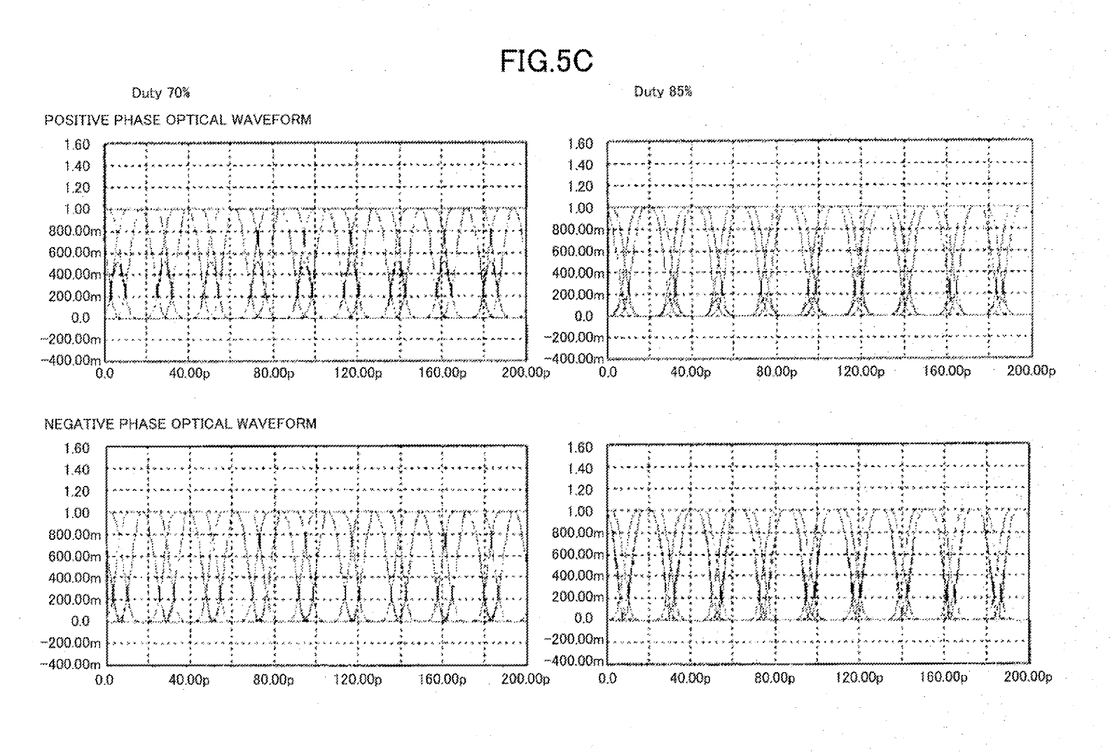

On the other hand, FIGS. 5A to 5C illustrate the waveform of the driver output signal (LNDRV waveform 45 Gbps), the waveform of the optical modulation signal (DPSK optical waveform), the electrical spectrum of the optical modulation signal, and the waveforms of the demodulation signal (positive optical waveform and negative optical waveform) when the duty ratio of the driver output signal is less than 100%. As the cases where the duty ratio of the driver output signal is less than 100%, FIGS. 5A to 5C illustrate a case where a duty ratio of the driver output signal is 70% and a case where a duty ratio of the driver output signal is 85%. As illustrated in FIGS. 5A to 5C, in a case where the duty ratio of the driver output signal is less than 100%, when compared with the case where the duty ratio of the driver output signal is 100%, the waveform of the optical modulation signal is doubled and the signal intensity of the f0 component is dropped (reduced). When this phenomenon occurs, an OSNR (Optical Signal to Noise Ratio) is more likely to be degraded when compared with the case where the duty ratio of the driver output signal is 100%.

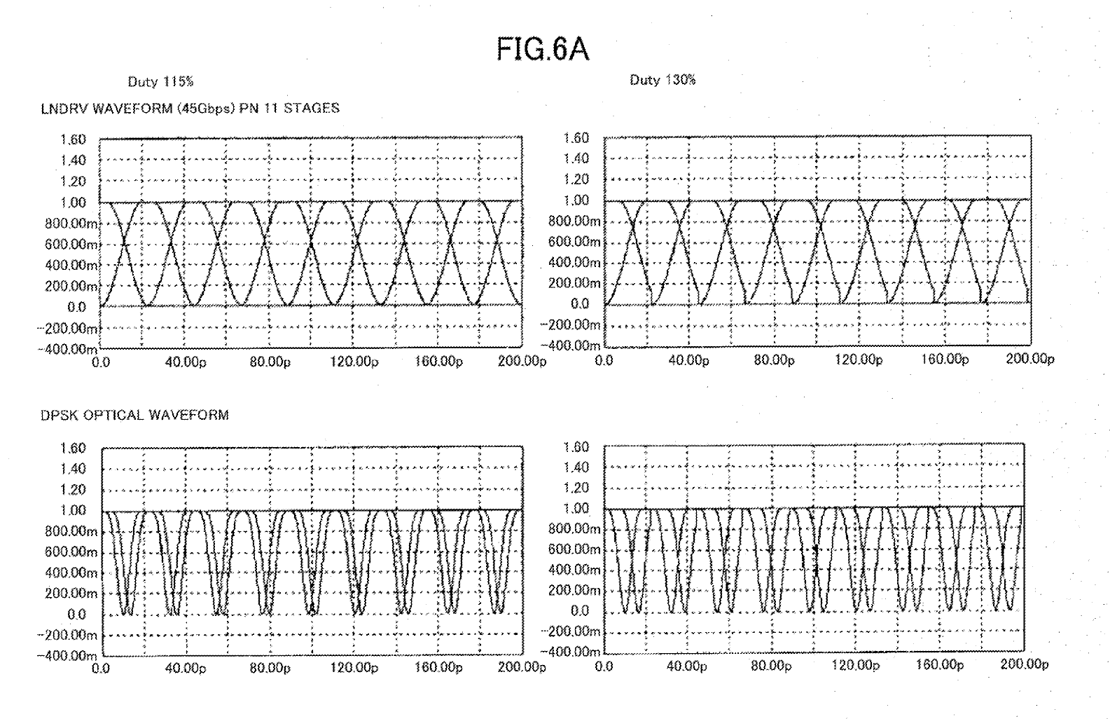

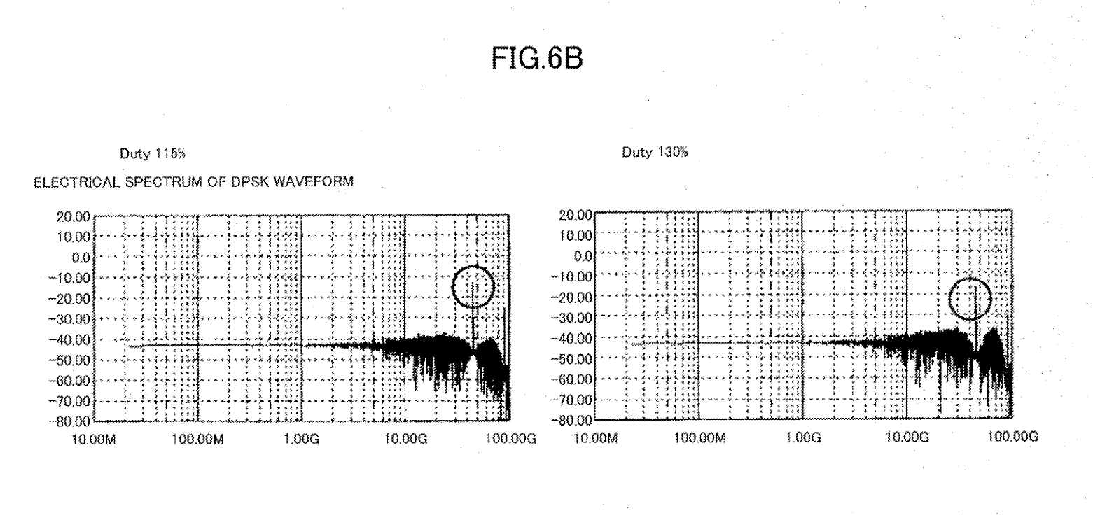

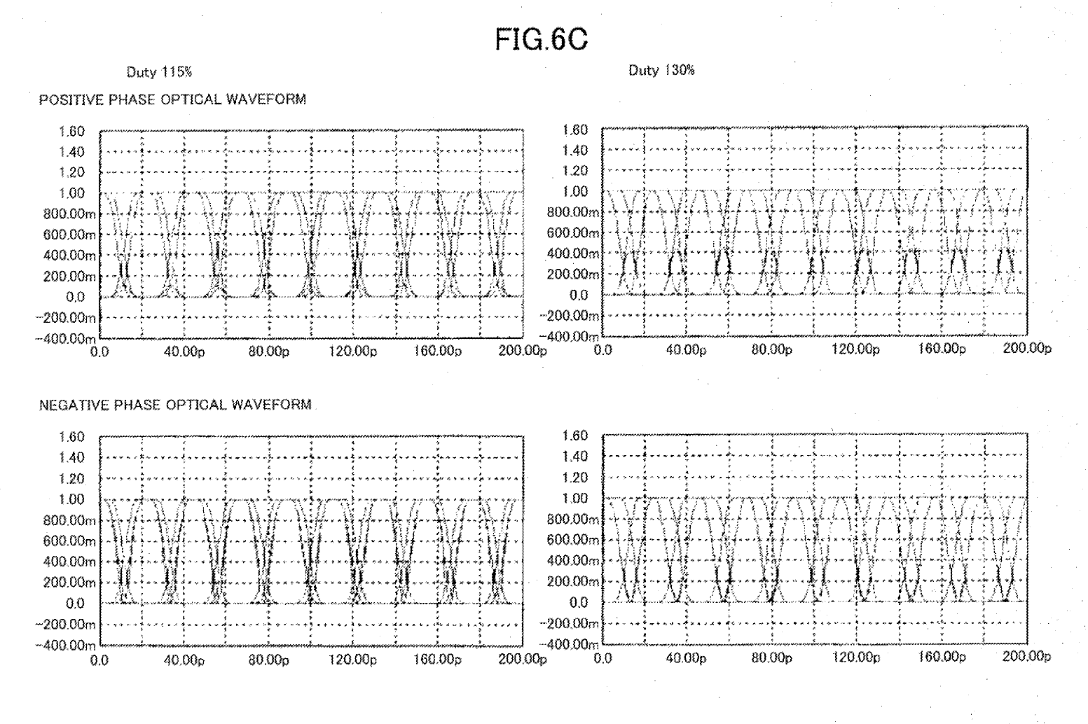

On the other hand, FIGS. 6A to 6C illustrate the waveform of the driver output signal (LNDRV waveform 45 Gbps), the waveform of the optical modulation signal (DPSK optical waveform), the electrical spectrum of the optical modulation signal, and the waveforms of the demodulation signal (positive optical waveform and negative optical waveform) when the duty ratio of the driver output signal is greater than 100%. As the cases where the duty ratio of the driver output signal is greater than 100%, FIGS. 6A to 6C illustrate a case where a duty ratio of the driver output signal is 115% and a case where a duty ratio of the driver output signal is 130%. As illustrated in FIGS. 6A to 6C, in a case where the duty ratio of the driver output signal is greater than 100%, when compared with the case where the duty ratio of the driver output signal is 100%, the waveform of the optical modulation signal is doubled and the signal intensity of the f0 component is dropped (reduced). When this phenomenon occurs, the OSNR (Optical Signal to Noise Ratio) is more likely to be degraded when compared with the case where the duty ratio of the driver output signal is 100%.

In consideration of the relationships among the change of the duty ratio of the driver output signal, the signal intensity of the f0 component, and the doubled waveform of the optical modulation signal (i.e., the degradation of the OSNR), the optical transmitter 11 according to the first embodiment of the present invention is configured to control the duty ratio of the driver output signal so as to maximize the signal intensity of the f0 component. By doing this, it may become possible to substantially or completely eliminate a possibility that the duty ratio of the driver output signal is far from 100%. In other words, substantially, it may become possible to maintain the duty ratio of the driver output signal at or near 100%. Therefore, in the optical transmitter 11 according to the first embodiment of the present invention, it may become possible to generate the driver output signal so as to control (prevent) the degradation of the quality of the optical modulation signal (i.e., the degradation of the OSNR). Namely, in the optical transmitter 11 according to the first embodiment of the present invention, it may become possible to drive the optical modulator 111 so as to control (prevent) the degradation of the quality of the optical modulation signal (i.e., the degradation of the OSNR).

In addition, in the optical transmitter 11 according to the first embodiment of the present invention, it may become possible to directly detect the f0 component of the electric signal that has been converted form optical modulation signal. When the f0 component is to be obtained directly from the optical modulation signal, an optical filter having a previously adjusted center frequency corresponding to the f0 component is to be used. However, the carrier frequency of the light output from the light source 10 may be changed. Because of this feature, it may be difficult to previously set the center frequency of the optical filter. On the other hand, according to the first embodiment of the present invention, it is configured to detect the f0 component of the electric signal, therefore the above-described technical inconvenience may not occur.

Further, it may be technically difficult to directly detect the duty ratio of the driver output signal. However, as described above, according to the first embodiment of the present invention, instead of directly detecting the duty ratio of the driver output signal, the signal intensity of the f0 component may be detected. By doing this, it may become possible to adjust the duty ratio of the driver output signal. Namely, by detecting signal intensity of the f0 component which may be more easily detected than by detecting the duty ratio of the driver output signal, it may become possible to easily adjust the duty ratio of the driver output signal.

Further, instead of modulating the driver output signal output from the modulator driver 112, the optical modulator 111 may modulate the light output from the light source 110 based on the driver output signal on which a predetermined bias signal is superimposed. As the predetermined bias signal, a low-frequency (i.e., the frequency is lower than that of the driver output signal) or a direct-current (DC) bias signal to be supplied from a bias voltage source (not shown) and to be superimposed on the driver output signal may be used. However, even when the bias signal is superimposed on the driver output signal, it is preferable that the duty-ratio adjuster 1121 controls the duty ratio of the driver output signal (i.e., the driver output signal before the bias signal is superimposed on the driver output signal) so as to maximize the signal intensity of the f0 component. This may also be applied to the second to the fourth embodiments (including their relevant modified examples) of the present invention described below.

Further, in addition to or instead of the duty ratio of the driver output signal, a duty ratio of the data signal or the modulation signal output from the MUX/precoder 113 may be additionally or alternatively controlled in the same manner as described above. In this case, the duty-ratio adjuster 1121 may be included in the MUX/precoder 113. This may also be applied to the second to the fourth embodiments (including their modified examples) of the present invention described below.

### (3) Modified Examples of Optical Transmitter in the First Embodiment

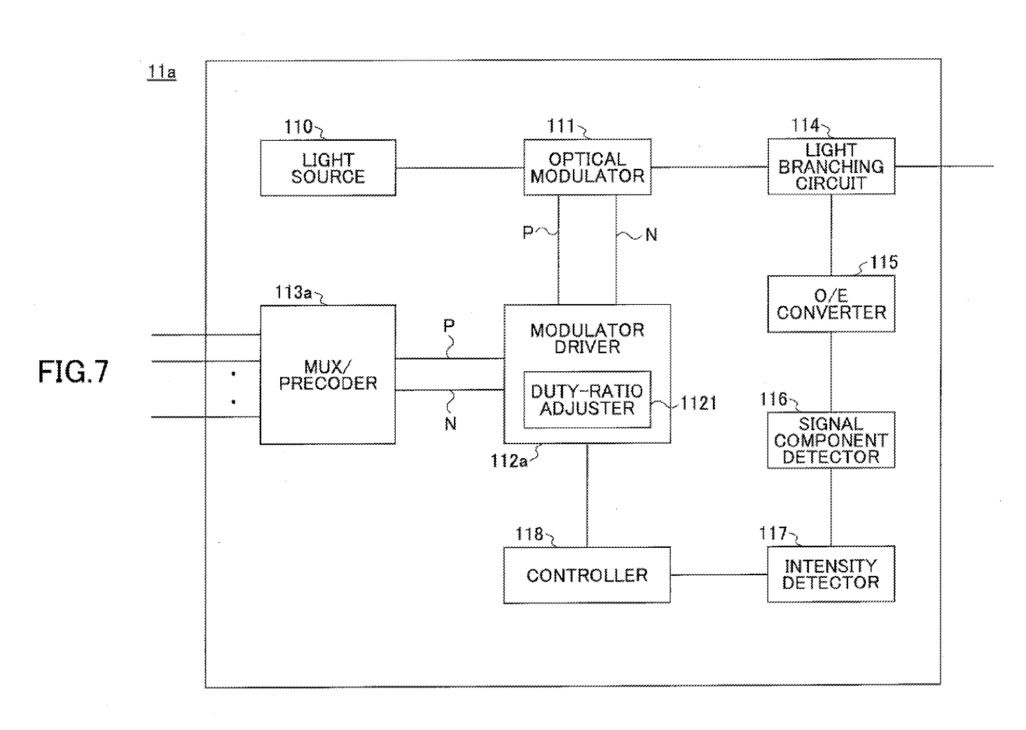

Various modified examples of the optical transmitter 11 in the first embodiment are described with reference to FIGS. 7 to 9.

### (3-1) First Modified Example of Optical Transmitter in the First Embodiment

A first modified example of the optical transmitter 11 in the first embodiment is described with reference to FIG. 7. FIG. 7 is an example block diagram illustrating a configuration of an optical transmitter 11a in the first modified example of the first embodiment. The same reference numerals are used to describe the same elements as those in the configuration of the optical transmitter 11 in the first embodiment described above, and the detailed descriptions thereof may be omitted.

As illustrated in FIG. 7, similar to the optical transmitter 11 in the first embodiment, the optical transmitter 11a in the first modified example includes the light source 110, the optical modulator 111, the light branching circuit 114, the O/E converter 115, the signal component detector 116, the intensity detector 117, and the controller 118. The optical transmitter 11a in the first modified example differs from the optical transmitter 11 in the first embodiment in that the optical transmitter 11a in the first modified example includes a differential-type modulator driver 112a and a differential-type MUX/precoder 113a.

The differential-type modulator driver 112a generates a driver output signal (positive phase (in phase):P) and a driver output signal (negative phase (inversed phase):N) to drive the optical modulator 111 (i.e., to cause the optical modulator 111 to modulate the light from the light source 110) in accordance with a modulation signal (p) and an inversion signal (N) which are output from the MUX/precoder 113a.

The MUX/precoder 113a generates the modulation signal (P) and the inversion signal (N) in accordance with a data signal having a high bit rate. The inversion signal (N) is generated by inverting the modulation signal (P). To that end, for example, the MUX/precoder 113a generates the modulation signal (P) and the inversion signal (N) generated by performing an encoding process reflecting difference information between a one bit previous code and the current code using the data signal having a high bit rate. The MUX/precoder 113a outputs the modulation signal (P) and the inversion signal (N) to the modulator driver 112a.

The optical transmitter 11a in the first modified example having the configuration described above may also produce the same effects as those produced by the optical transmitter 11 according to the first embodiment described above.

### (3-2) Second Modified Example of Optical Transmitter in the First Embodiment

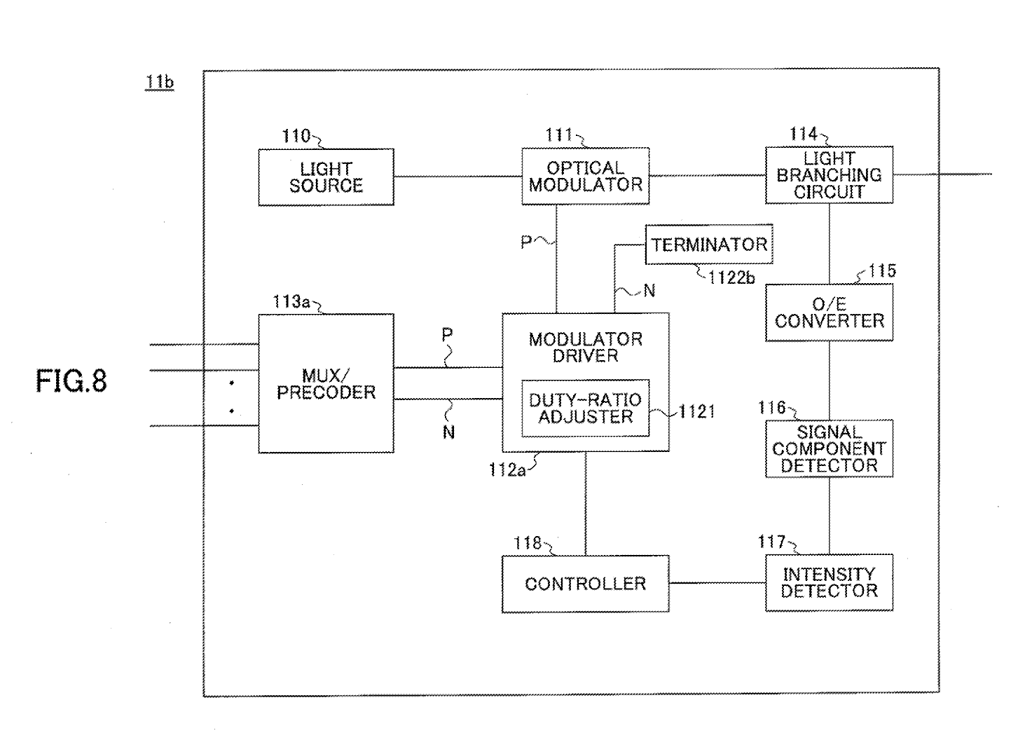

A second modified example of the optical transmitter 11 in the first embodiment is described with reference to FIG. 8. FIG. 8 is an example block diagram illustrating a configuration of an optical transmitter 11b in the second modified example of the first embodiment. The same reference numerals are used to describe the same elements as those in the configurations of the optical transmitter 11 in the first embodiment and the optical transmitter 11a in the first modified example, and the detailed descriptions thereof may be omitted.

As illustrated in FIG. 8, similar to the optical transmitter 11a in the first modified example, the optical transmitter 11b in the second modified example includes the light source 110, the optical modulator 111, the differential-type modulator driver 112a, the differential-type MUX/precoder 113a, the light branching circuit 114, the O/E converter 115, the signal component detector 116, the intensity detector 117, and the controller 118. The optical transmitter 11b in the second modified example differs from the optical transmitter 11a in the first modified example in that one of the two output terminals of the differential-type modulator driver 112a is terminated by a terminator 1122b. Namely, in the optical transmitter 11b in the second modified example, one of the two output terminals of the differential-type modulator driver 112a to output the driver output signal (positive phase:P) and the driver output signal (negative phase:N) is terminated by the terminator 1122b.

FIG. 8 illustrates a case where the output terminal of the differential-type modulator driver 112a to output the driver output signal (negative phase:N) is terminated by the terminator 1122b. Therefore, in this case, the optical modulator 111 modulates the light output from the light source 110 in accordance with the driver output signal (positive phase:P).

However, alternatively, the output terminal of the differential-type modulator driver 112a to output the driver output signal (positive phase:P) may be terminated by the terminator 1122b. In this case, the optical modulator 111 may modulate the light output from the light source 110 in accordance with the driver output signal (negative phase:N).

The optical transmitter 11b in the second modified example having the configuration described above may also produce the same effects as those produced by the optical transmitter 11 according to the first embodiment described above.

### (3-3) Third Modified Example of Optical Transmitter in the First Embodiment

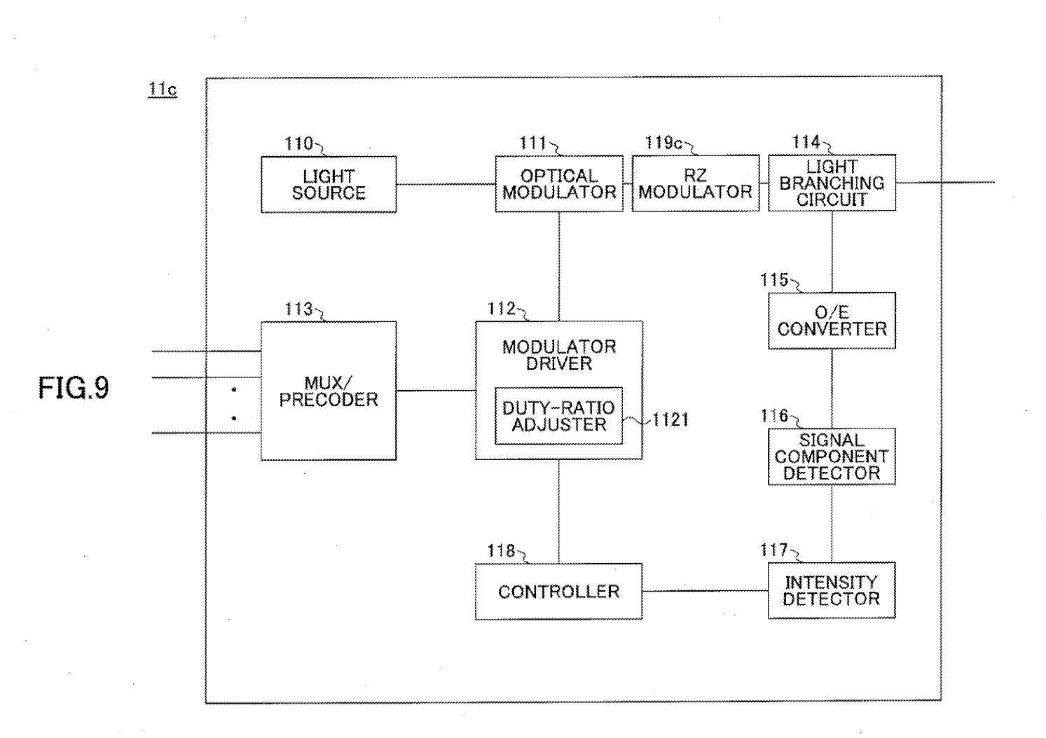

A third modified example of the optical transmitter 11 in the first embodiment is described with reference to FIG. 9. FIG. 9 is an example block diagram illustrating a configuration of an optical transmitter 11c in the third modified example of the first embodiment. The same reference numerals are used to describe the same elements as those in the configurations of the optical transmitter 11 in the first embodiment, the optical transmitter 11a in the first modified example, and the optical transmitter 11b in the second modified example, and the detailed descriptions thereof may be omitted.

As illustrated in FIG. 9, similar to the optical transmitter 11 in the first embodiment, the optical transmitter 11c in the third modified example includes the light source 110, the optical modulator 111, the modulator driver 112, the MUX/precoder 113, the light branching circuit 114, the O/E converter 115, the signal component detector 116, the intensity detector 117, and the controller 118. The optical transmitter 11c in the third modified example differs from the optical transmitter 11 in the first embodiment in that the optical transmitter 11c further includes an RZ (Return to Zero) modulator 119c. The RZ modulator 119c may be integrated in the optical modulator 111 as a part of the optical modulator 111.

The RZ modulator 119c performs an RZ pulsing operation on the light output from the optical modulator 111 (i.e., the DPSK-modulated light modulation signal). As a result, the RZ modulator 119c outputs the light on which the RZ pulsing operation is performed (i.e., an RZ-DPSK modulated optical modulation signal) to the light branching circuit 114.

The optical transmitter 11c in the third modified example having the configuration described above may also produce the same effects as those produced by the optical transmitter 11 according to the first embodiment described above.

### (4) Optical Transmitter According to a Second Embodiment of the Present Invention

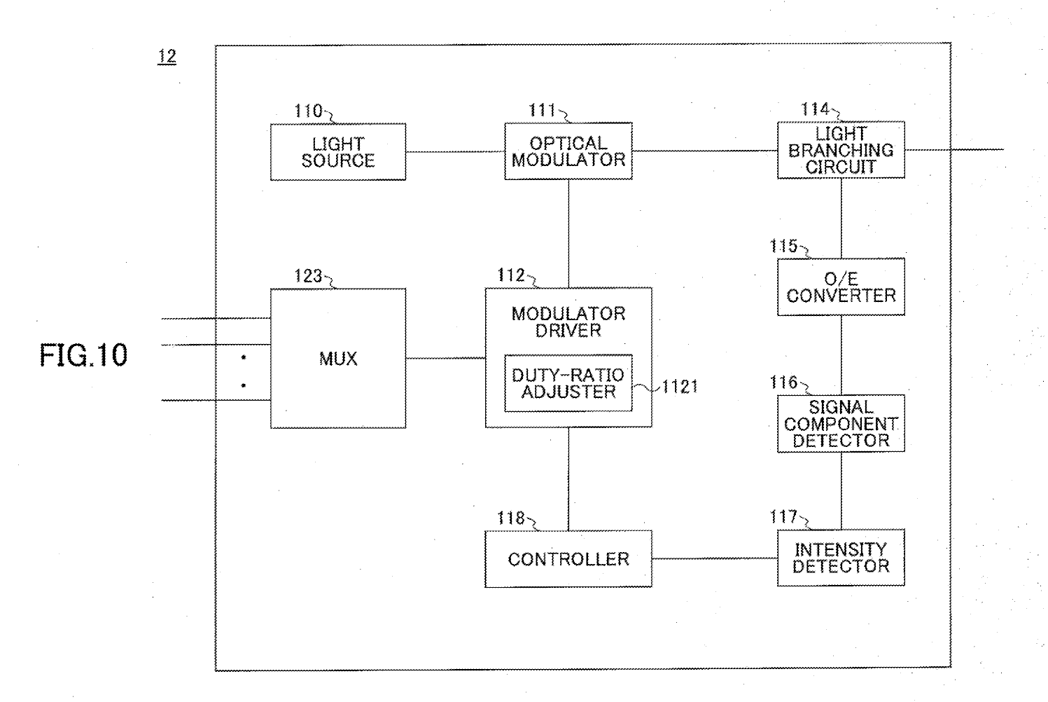

An optical transmitter 12 according to the second embodiment of the present invention is described with reference to FIGS. 10 to 14. The same reference numerals and the same operation numbers are used to describe the same elements and the same processes as those in the configurations of the optical transmitter 11 in the first embodiment, the optical transmitter 11a in the first modified example, the optical transmitter 11b in the second modified example, and the optical transmitter 11c in the third modified example, and the detailed descriptions thereof may be omitted. Further, as described above, FIG. 1 illustrates the optical transmission system 1 including the optical transmitters 11. However, alternatively, the optical transmission system 1 may includes the optical transmitters 12 instead of the optical transmitters 11. Otherwise, the optical transmission system 1 may includes both the optical transmitter 11 and the optical transmitter 12.

### (4-1) Configuration of Optical Transmitter According to the Second Embodiment of the Present Invention

An example configuration of the optical transmitter 12 according to the second embodiment of the present invention is described with reference to FIG. 10. FIG. 10 is an example block diagram of a configuration of the optical transmitter 12 according to the second embodiment of the present invention.

As illustrated in FIG. 10, similar to the optical transmitter 11 in the first embodiment, the optical transmitter 12 in the second embodiment includes the light source 110, the optical modulator 111, the modulator driver 112, the light branching circuit 114, the O/E converter 115, the signal component detector 116, the intensity detector 117, and the controller 118. The optical transmitter 12 in the second embodiment differs from the optical transmitter 11 in the first embodiment in that the optical modulator 111 employs an NRZ (Non Return to Zero) modulation scheme (i.e., an OKK (On Off Keying) modulation scheme). Further, the optical transmitter 12 in the second embodiment differs from the optical transmitter 11 in the first embodiment in that the optical transmitter 12 includes an MUX 123 instead of the MUX/precoder 113. Namely, the optical transmitter 12 in the second embodiment differs from the optical transmitter 11 in the first embodiment in that it is not necessary for the optical transmitter 12 to include the precoder.

The MUX 123 generates a data signal having a high bit rate (e.g., tens of Gbps) by multiplying plural data signals having a low bit rate (e.g., several hundreds of Mbps) supplied from outside of the optical transmitter 11. The MUX 123 outputs the generated modulation signal to the modulator driver 112.

### (4-2) Operations of Optical Transmitter According to the Second Embodiment of the Present Invention

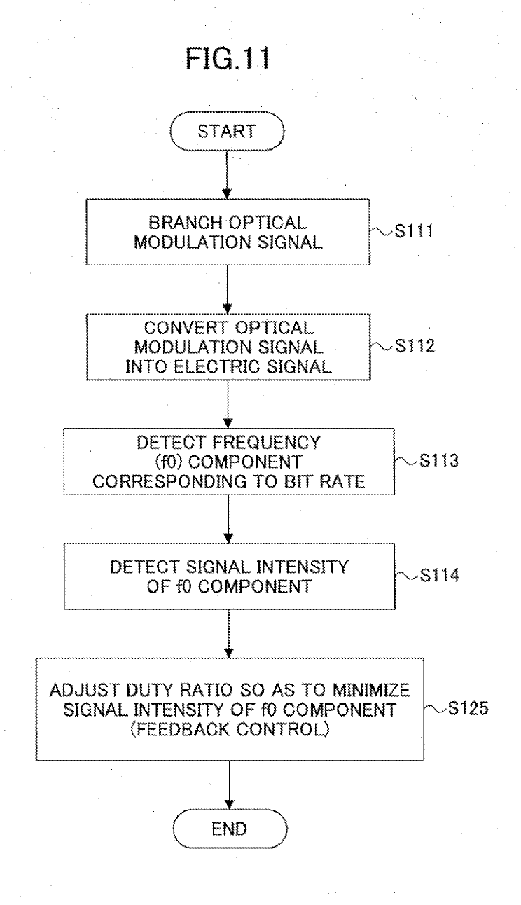

Operations of the optical transmitter 12 according to the second embodiment of the present invention are described with reference to FIG. 11. FIG. 11 is an example flowchart illustrating an operational procedure of the optical transmitter 12 according to the second embodiment of the present invention. Further, in the following, the description is focused on an adjusting operation of adjusting the duty ratio of the driver output signal from among the operations of the optical transmitter 12 according to the second embodiment of the present invention.

As illustrated in FIG. 11, in the optical transmitter 12 according to the second embodiment of the present invention, similar to the optical transmitter 11 according to the first embodiment of the present invention, the light branching circuit 114 branches the optical modulation signal output from the optical modulator 111 (operation S111). The light branching circuit 114 outputs the branched optical modulation signal to the O/E converter 115. The O/E converter 115 converts the optical modulation signal into the electric signal (operation S112). Next, the O/E converter 115 outputs the electric signal to the signal component detector 116. Then, the signal component detector 116 detects the frequency component (f0 component) corresponding to the bit rate of the optical modulation signal (operation S113). The signal component detector 116 outputs the detected f0 component to the intensity detector 117. Then, the intensity detector 117 detects the signal intensity of the f0 component corresponding to the bit rate (operation S114). Then, the intensity detector 117 outputs the detected signal intensity of the f0 component to the controller 118.

In this second embodiment, after the operation in operation 5114, the controller 118 adjusts the duty ratio of the driver output signal so as to minimize the signal intensity of the f0 component detected by the intensity detector 117 (operation S125). Specifically, for example, the controller 118 adjusts the duty ratio of the driver output signal in a manner such that the signal intensity of the f0 component after the adjustment of the duty ratio is less than the signal intensity of the f0 component before the adjustment of the duty ratio (i.e., the signal intensity of f0 component detected by the intensity detector 117).

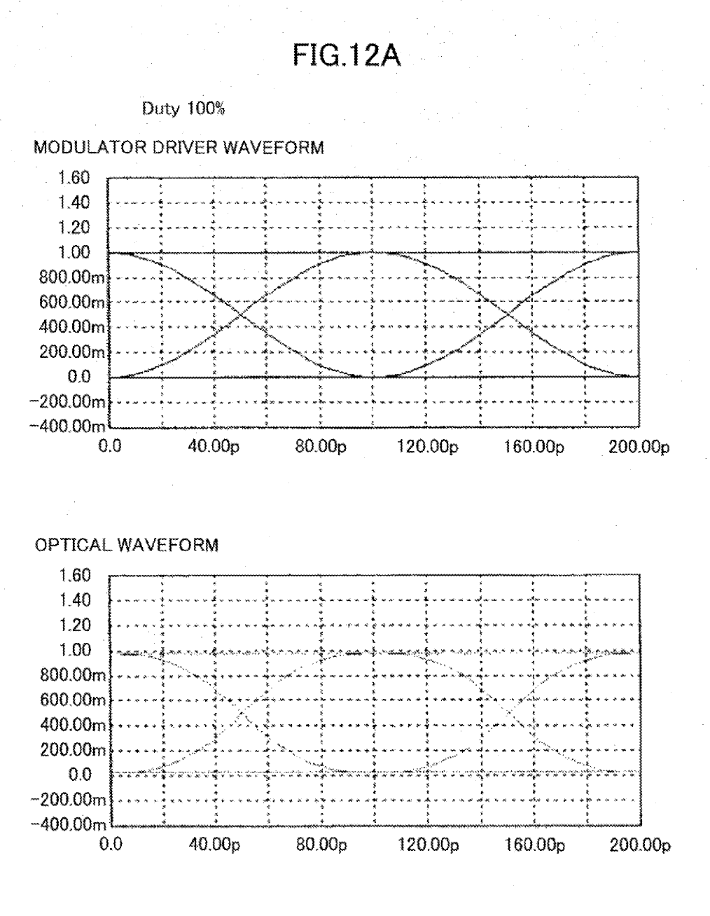

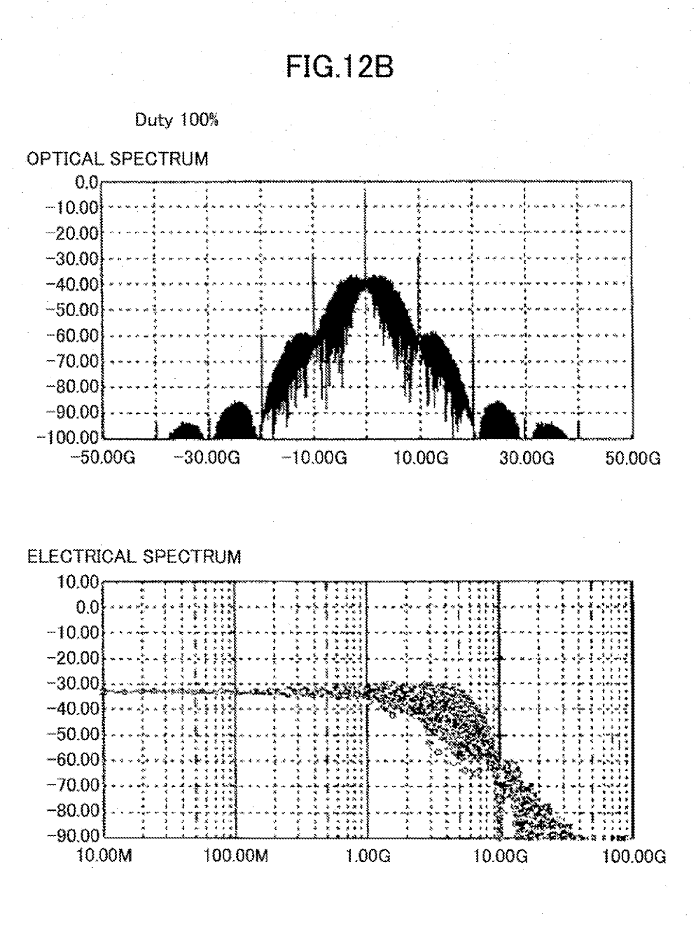

Herein, a technical meaning of the adjustment of the duty ratio of the driver output signal so as to minimize the signal intensity of the f0 component corresponding to the bit rate when the optical modulator 111 employs the NRZ modulation scheme is described with reference to FIGS. 12 to 14. FIGS. 12 to 14 are graphs illustrating waveforms of the driver output signal, the optical modulation signal, and the optical spectrum and the electrical spectrum of the optical modulation signal when the duty ratio of the driver output signal is changed.

FIGS. 12A and 12B illustrate the waveform of the driver output signal (modulator driver waveform), the waveform of the optical modulation signal (optical waveform), and the optical spectrum waveform and the electrical spectrum waveform of the optical modulation signal when the duty ratio of the driver output signal is 100%.

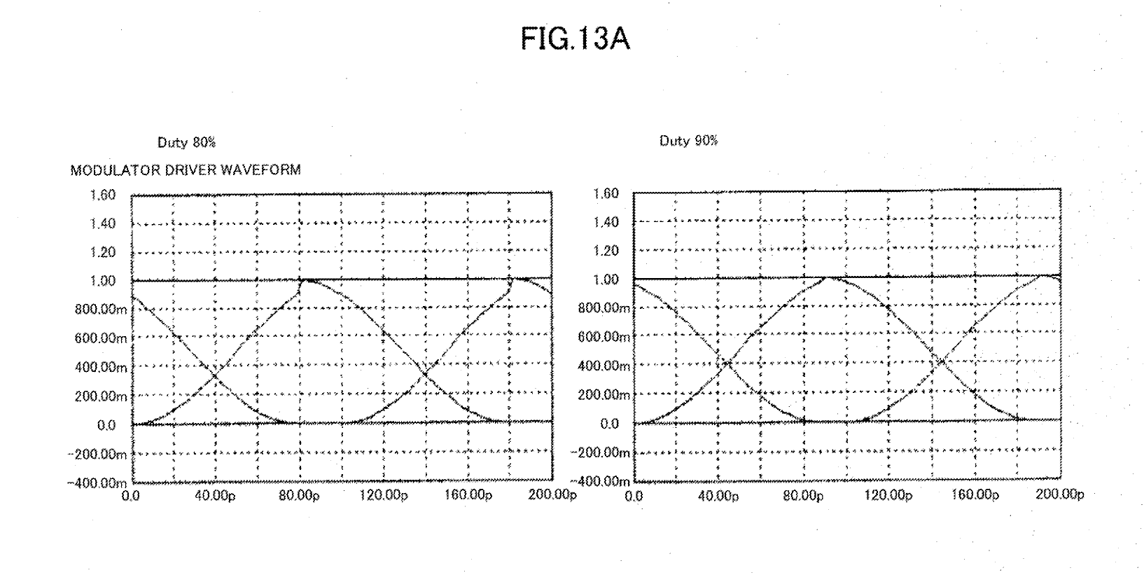

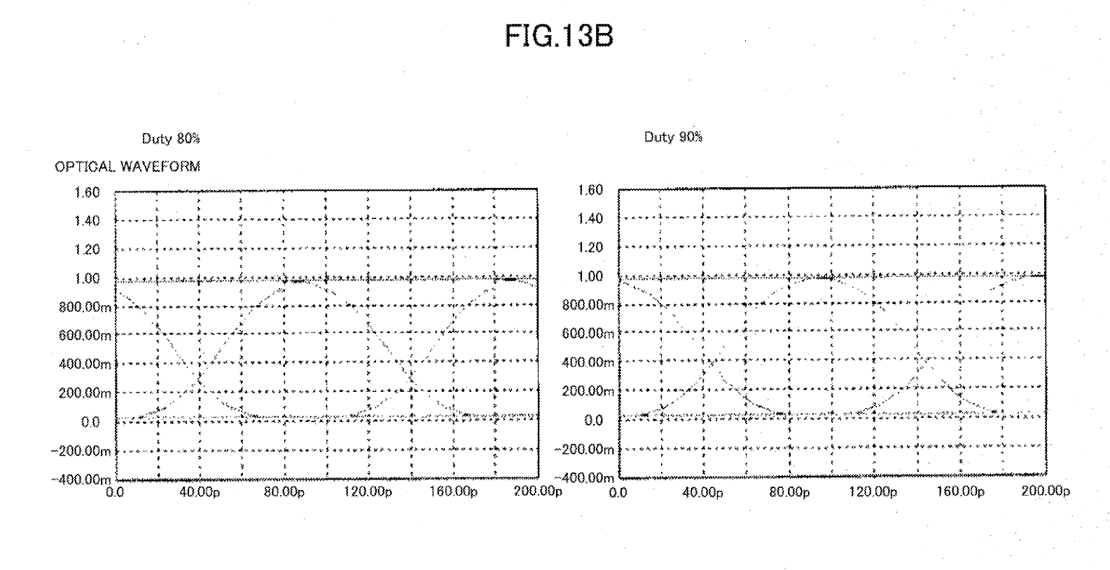

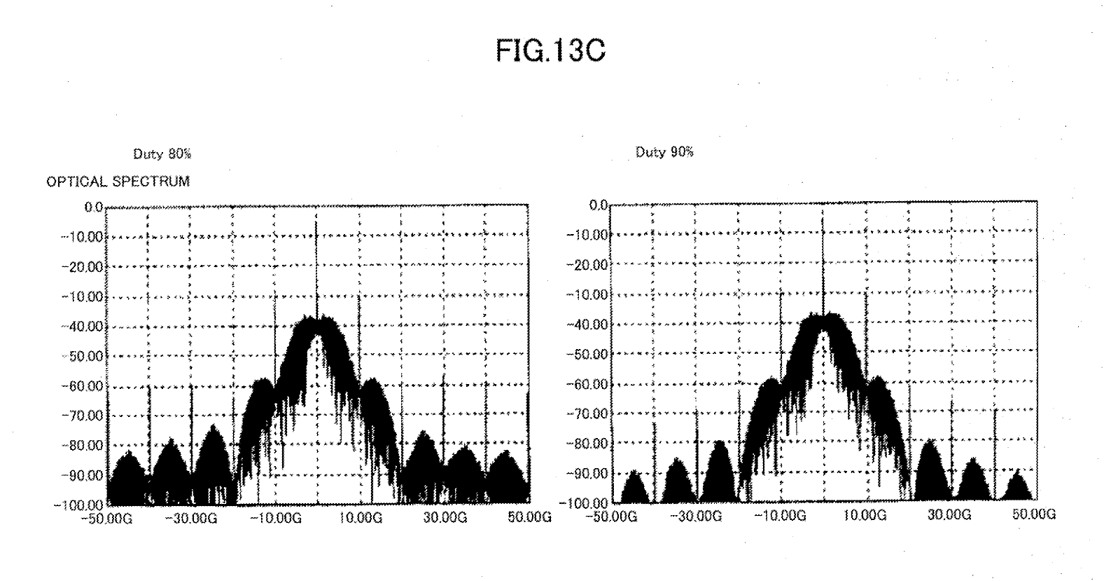

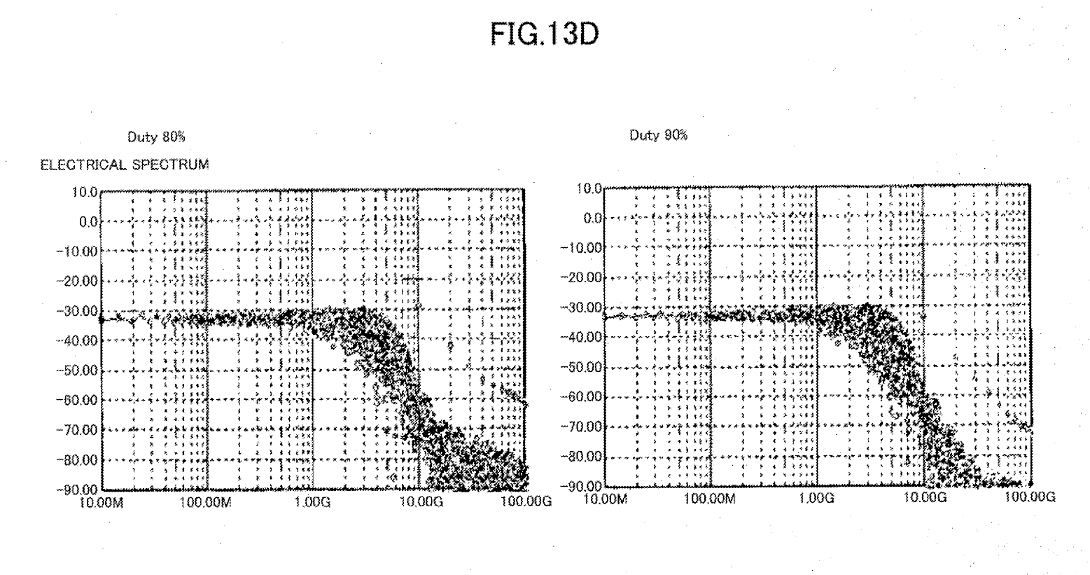

On the other hand, FIGS. 13A to 13D illustrate the waveform of the driver output signal (modulator driver waveform), the waveform of the optical modulation signal (optical waveform), and the optical spectrum waveform and the electrical spectrum waveform of the optical modulation signal when the duty ratio of the driver output signal is less than 100%. As the cases where the duty ratio of the driver output signal is less than 100%, FIGS. 13A to 13D illustrates case where a duty ratio of the driver output signal is 80% and a case where a duty ratio of the driver output signal is 90%. As illustrated in FIGS. 13A to 13D, in a case where the duty ratio of the driver output signal is less than 100%, when compared with the case where the duty ratio of the driver output signal is 100%, the waveform of the optical modulation signal is deformed and the signal intensity of the f0 component is increased (becomes higher). When this phenomenon occurs, the OSNR is more likely to be degraded when compared with the case where the duty ratio of the driver output signal is 100%.

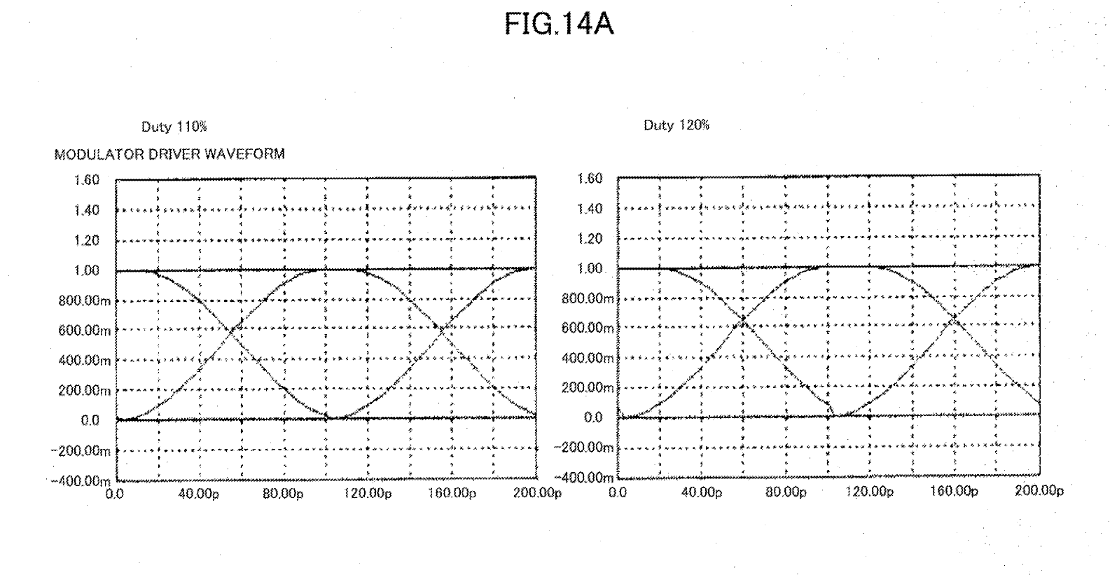

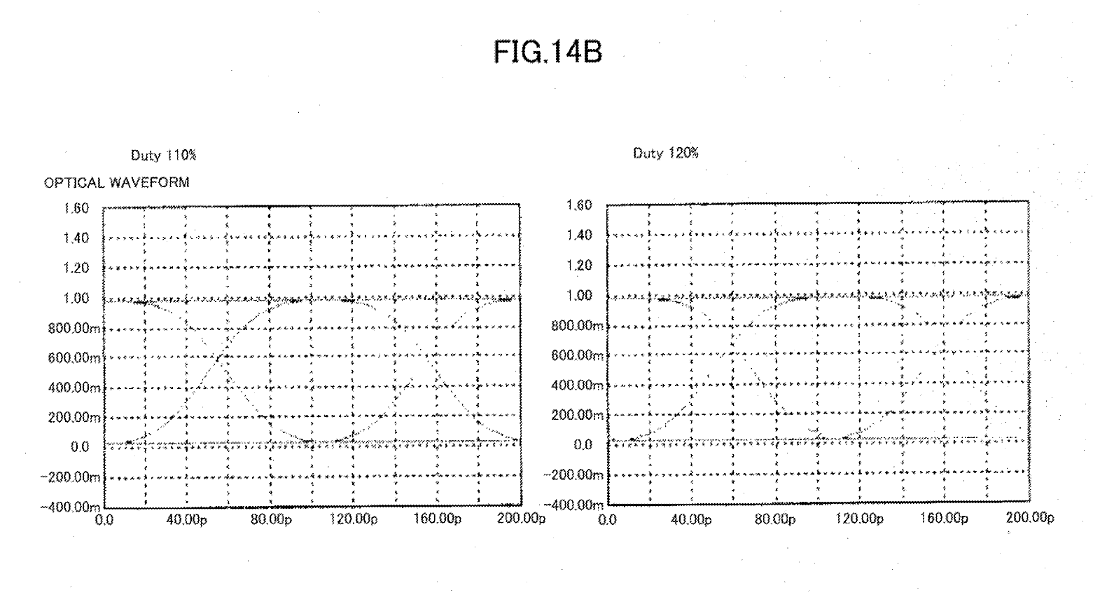

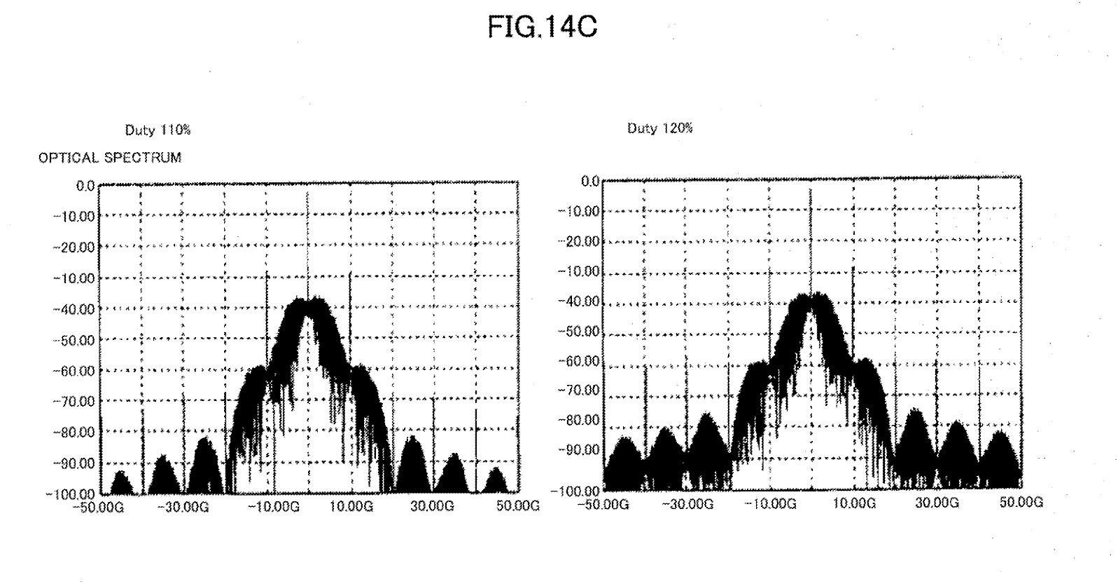

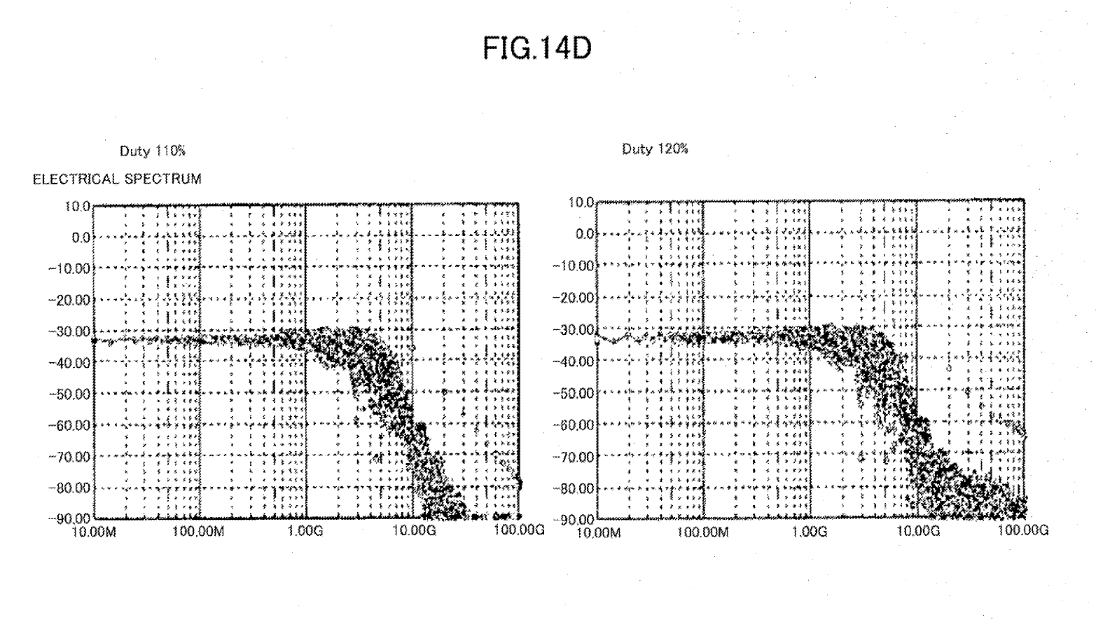

On the other hand, FIGS. 14A to 14D illustrate the waveform of the driver output signal (modulator driver waveform), the waveform of the optical modulation signal (optical waveform), and the optical spectrum waveform and the electrical spectrum waveform of the optical modulation signal when the duty ratio of the driver output signal is greater than 100%. As the cases where the duty ratio of the driver output signal is greater than 100%, FIGS. 14A to 14D illustrate a case where a duty ratio of the driver output signal is 110% and a case where a duty ratio of the driver output signal is 120%. As illustrated in FIGS. 6A to 6C, in a case where the duty ratio of the driver output signal is greater than 100%, when compared with the case where the duty ratio of the driver output signal is 100%, the waveform of the optical modulation signal is deformed and the signal intensity of the f0 component is increased (becomes higher). When this phenomenon occurs, the OSNR is more likely to be degraded when compared with the case where the duty ratio of the driver output signal is 100%.

In consideration of the relationships among the change of the duty ratio of the driver output signal, the signal intensity of the f0 component, and the deformed waveform of the optical modulation signal (i.e., the degradation of the OSNR), the optical transmitter 12 according to the second embodiment of the present invention is configured to control the duty ratio of the driver output signal so as to minimize the signal intensity of the f0 component. By doing this, it may become possible to substantially or completely eliminate a possibility that the duty ratio of the driver output signal is far from 100%. In other words, substantially, it may become possible to maintain the duty ratio of the driver output signal at or near 100%. Therefore, in the optical transmitter 12 according to the second embodiment of the present invention, it may become possible to drive the optical modulator 111 so as to control (prevent) the degradation of the quality of the optical modulation signal (i.e., the degradation of the OSNR). Namely, the optical transmitter 12 according to the second embodiment of the present invention having the configuration described above may also produce the same effects as those produced by the optical transmitter 11 according to the first embodiment.

Further, as illustrated in FIGS. 13 and 14, in a case where the duty ratio of the driver output signal is less than or greater than 100%, when compared with the case where the duty ratio of the driver output signal is 100%, not only the signal intensity of f0 component but also the signal intensity of the multiplication of the f0 component is increased (becomes high). Therefore, instead of adjusting the duty ratio so as to minimize the signal intensity of the f0 component, the duty ratio may be adjusted so as to minimize the signal intensity of the multiplication of the f0 component or so as to minimize the signal intensity of the f0 component and the multiplication of the f0 component as well.

### (5) Optical Transmitter According to a Third Embodiment of the Present Invention

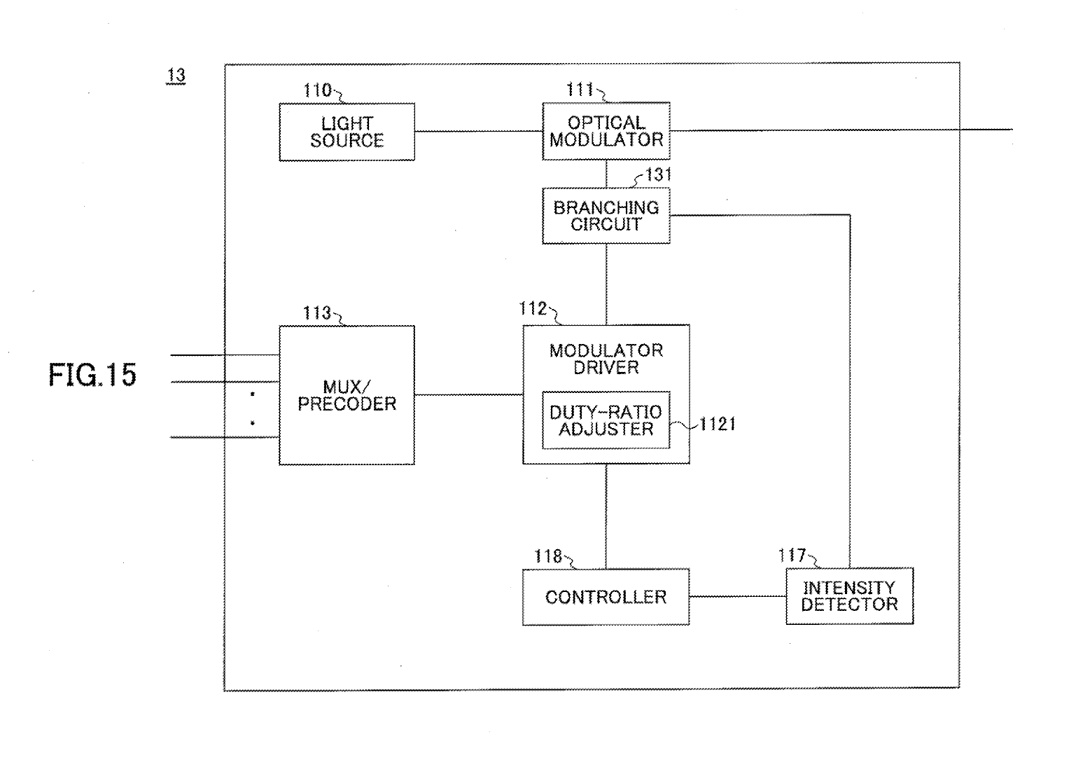

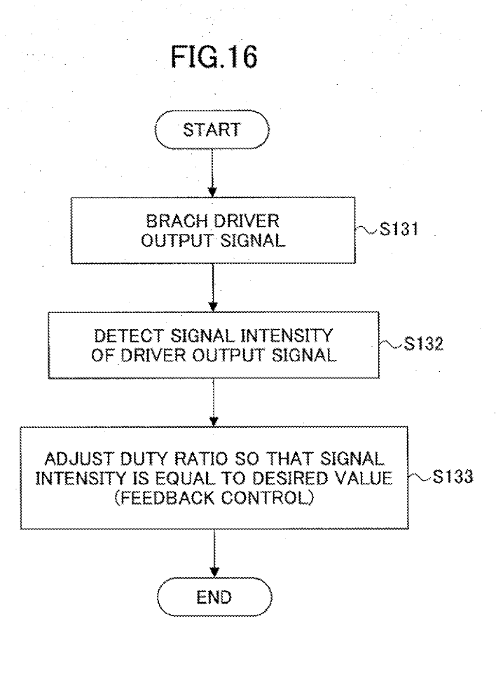

An optical transmitter 13 according to the third embodiment of the present invention is described with reference to FIGS. 15 and 16. The same reference numerals and the same operation numbers are used to describe the same elements and the same processes as those in the configurations of the optical transmitter 11 in the first embodiment, the optical transmitter 11a in the first modified example, the optical transmitter 11b in the second modified example, the optical transmitter 11c in the third modified example, and the optical transmitter 12 in the second embodiment, and the detailed descriptions thereof may be omitted. Further, as described above, FIG. 1 illustrates the optical transmission system 1 including the optical transmitters 11. However, alternatively, the optical transmission system 1 may includes the optical transmitters 13 instead of the optical transmitters 11. Otherwise, the optical transmission system 1 may includes both the optical transmitter 11 along with the optical transmitter 13.

### (5-1) Configuration of Optical Transmitter According to the Third Embodiment of the Present Invention

An example configuration of the optical transmitter 13 according to the third embodiment of the present invention is described with reference to FIG. 15. FIG. 15 is an example block diagram of a configuration of the optical transmitter 13 according to the third embodiment of the present invention.

As illustrated in FIG. 15, similar to the optical transmitter 11 in the first embodiment, the optical transmitter 13 in the third embodiment includes the light source 110, the optical modulator 111, the modulator driver 112, the MUX/precoder 113, the intensity detector 117, and the controller 118. The optical transmitter 13 in the third embodiment differs from the optical transmitter 11 in the first embodiment in that it is not necessary for the optical transmitter 13 to include the light branching circuit 114, the O/E converter 115, and the signal component detector 116. Therefore, in the optical transmitter 13 of the third embodiment, the light output from the optical modulator 111 (i.e., the optical modulation signal) may be output to the outside of the optical transmitter 13 without being branched.

Further, the optical transmitter 13 in the third embodiment differs from the optical transmitter 11 in the first embodiment in that the optical transmitter 13 further includes a branching circuit 131. The branching circuit 131 branches the driver output signal output from the modulator driver 112 to output the driver output signal to the optical modulator 111 and the intensity detector 117.

Further, when the bias signal is superimposed on the driver output signal, it is preferable that the branching circuit 131 branches the driver output signal alone (i.e., the driver output signal on which the bias signal has not been superimposed).

The intensity detector 117 detects the signal intensity of the driver output signal (e.g., the average signal intensity). The intensity detector 117 outputs the detected signal intensity of the driver output signal to the controller 118. The controller 118 adjusts the duty ratio of the driver output signal in accordance with the signal intensity of the driver output signal detected by the intensity detector 117. More specifically, the controller 118 adjusts the duty ratio of the driver output signal in a manner such that the signal intensity of the driver output signal is substantially equal to a desired value.

### (5-2) Operations of Optical Transmitter According to the Third Embodiment of the Present Invention

Operations of the optical transmitter 13 according to the third embodiment of the present invention are described with reference to FIG. 16. FIG. 16 is an example flowchart illustrating an operational procedure of the optical transmitter 13 according to the third embodiment of the present invention. Further, in the following, the description is focused on an adjusting operation of adjusting the duty ratio of the driver output signal from among the operations of the optical transmitter 13 according to the third embodiment of the present invention.

As illustrated in FIG. 16, the branching circuit 131 branches the driver output signal output from the modulator driver 112 (operation S131). The branching circuit 131 outputs the branched driver output signal to the intensity detector 117.

Then, the intensity detector 117 detects the signal intensity of the driver output signal (operation S132). The intensity detector 117 outputs the detected signal intensity of the driver output signal to the controller 118.

Then, the controller 118 adjusts the duty ratio of the driver output signal in a manner such that the signal intensity of the driver output signal detected by the intensity detector 117 is substantially equal to a desired value (operation S133). In this case, as the “desired value”, it is preferable that a value indicating the signal intensity of the driver output signal when the duty ratio is 100% be set in advance. Therefore, it is also preferable that controller 118 stores the value indicating the signal intensity of the driver output signal when the duty ratio is 100% inside the controller 118 or in an external memory (not shown) in advance.

As a result, in the optical transmitter 13 according to the third embodiment of the present invention, the duty ratio of the driver output signal is adjusted in a manner such that the signal intensity of the driver output signal detected by the intensity detector 117 is substantially equal to, for example, the signal intensity of the driver output signal when the duty ratio is 100%. Therefore, by doing this, it may become possible to substantially or completely eliminate a possibility that the duty ratio of the driver output signal is far from 100%. In other words, substantially, it may become possible to maintain the duty ratio of the driver output signal at or near 100%. Therefore, in the optical transmitter 12 according to the second embodiment of the present invention, it may become possible to drive the optical modulator 111 so as to control (prevent) the degradation of the quality of the optical modulation signal (i.e., the degradation of the OSNR). Namely, the optical transmitter 13 according to the third embodiment of the present invention having the configuration described above may also produce the same effects as those produced by the optical transmitter 11 according to the first embodiment.

Further, alternatively, the intensity detector 117 may detect not only the signal intensity of the driver output signal but also the signal intensity of the data signal having the high bit rate or the modulation signal output from the MUX/precoder 113. Otherwise, the intensity detector 117 may detect only the signal intensity of the data signal having the high bit rate or the modulation signal output from the MUX/precoder 113. In this case, the duty-ratio adjuster 1121 may adjust (control) the duty ratio of the data signal, modulation signal, or the driver output signal in a manner such that the signal intensity of the data signal having the high bit rate or the modulation signal is substantially equal to the signal intensity of the data signal having the high bit rate or the modulation signal, respectively, when the duty ratio is 100%. This may also be applied to each of the modified embodiments of the third embodiment of the present invention.

### (6) Modified Examples of Optical Transmitter in the Third Embodiment

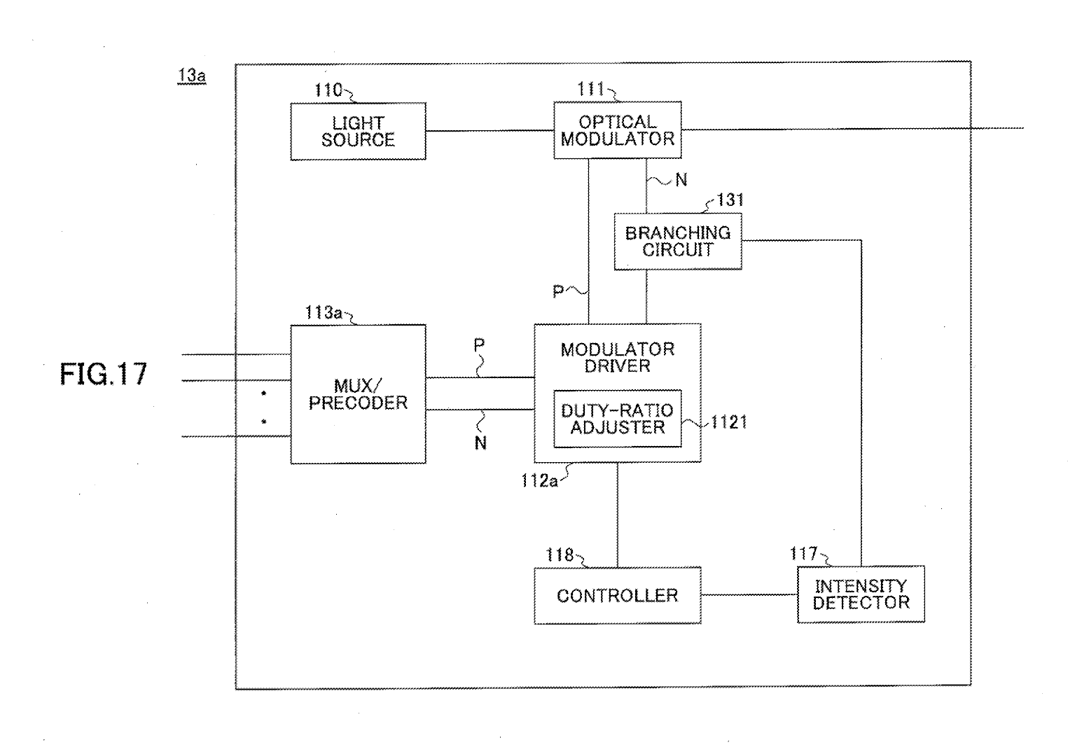

Various modified examples of the optical transmitter 13 in the third embodiment are described with reference to FIGS. 17 to 21.

### (6-1) First Modified Example of Optical Transmitter in the Third Embodiment

A first modified example of the optical transmitter 13 in the third embodiment is described with reference to FIG. 17. FIG. 17 is an example block diagram illustrating a configuration of an optical transmitter 13a in the first modified example of the third embodiment.

As illustrated in FIG. 17, similar to the optical transmitter 13 in the third embodiment, the optical transmitter 13a in the first modified example includes the light source 110, the optical modulator 111, the intensity detector 117, the controller 118, and the branching circuit 131. The optical transmitter 13a in the first modified example differs from the optical transmitter 13 in the third embodiment in that the optical transmitter 13a in the first modified example includes the differential-type modulator driver 112a and the differential-type MUX/precoder 113a.

The branching circuit 131 branches and outputs one of the driver output signal (positive phase:P) and the driver output signal (negative phase:N) output from the modulator driver 112a to the intensity detector 117. For example, FIG. 17 illustrates a case where the branching circuit 131 branches and outputs the driver output signal (negative phase:N) to the intensity detector 117.

The optical transmitter 13a in the first modified example having the configuration described above may also produce the same effects as those produced by the optical transmitter 13 according to the third embodiment described above.

### (6-2) Second Modified Example of Optical Transmitter in the Third Embodiment

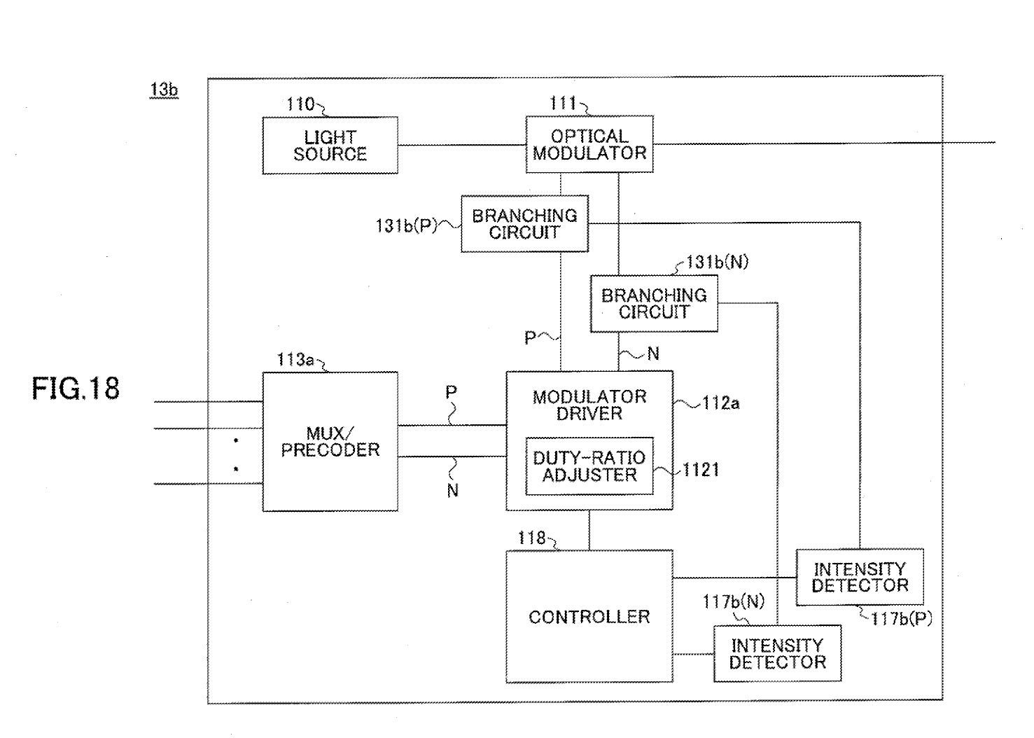

A second modified example of the optical transmitter 13 in the third embodiment is described with reference to FIG. 18. FIG. 18 is an example block diagram illustrating a configuration of an optical transmitter 13b in the second modified example of the third embodiment.

As illustrated in FIG. 18, similar to the optical transmitter 13a in the first modified example, the optical transmitter 13b in the second modified example includes the light source 110, the optical modulator 111, the differential-type modulator driver 112a, the differential-type MUX/precoder 113a, and the controller 118. The optical transmitter 13b in the second modified example differs from the optical transmitter 13a in the first modified example in that the optical transmitter 13b includes two branching circuits 131 and two intensity detectors 117.

Specifically, the optical transmitter 13b in the second modified example includes a branching circuit 131b(P) and a branching circuit 131b(N). The branching circuit 131b(P) branches the driver output signal (positive phase:P) output from the modulator driver 112a. The branching circuit 131b(N) branches the driver output signal (negative phase:N) output from the modulator driver 112a. Further, the optical transmitter 13b in the second modified example includes an intensity detector 117b(P) and an intensity detector 117b(N). The intensity detector 117b(P) detects the signal intensity of the driver output signal (positive phase:P) branched by the branching circuit 131b(P). The intensity detector 117b(N) detects the signal intensity of the driver output signal (negative phase:N) branched by the branching circuit 131b(N).

The controller 118 adjusts the duty ratio of the driver output signal in accordance with the signal intensity of the driver output signal (positive phase:P) detected by the intensity detector 117b(P) or the signal intensity of the driver output signal (positive phase:N) detected by the intensity detector 117b(N), or both.

The optical transmitter 13b in the second modified example having the configuration described above may also produce the same effects as those produced by the optical transmitter 13 according to the third embodiment described above.

Further, in the optical transmitter 13b of the second modified example, even when one of the signal quality of the driver output signal (positive phase:P) and the signal quality of the driver output signal (positive phase:N) is degraded, it may become possible to adjust the duty ratio of the driver output signal in accordance with the other of the signal quality of the driver output signal (positive phase:P) and the signal quality of the driver output signal (positive phase:N). By having this feature, it may become possible to ensure the redundancy of the driver output signal to be referred to to adjust the duty ratio of the driver output signal. As a result, it may become possible to relatively enhance the reliability of the adjusting operation of adjusting the duty ratio of the driver output signal.

### (6-3) Third Modified Example of Optical Transmitter in the Third Embodiment

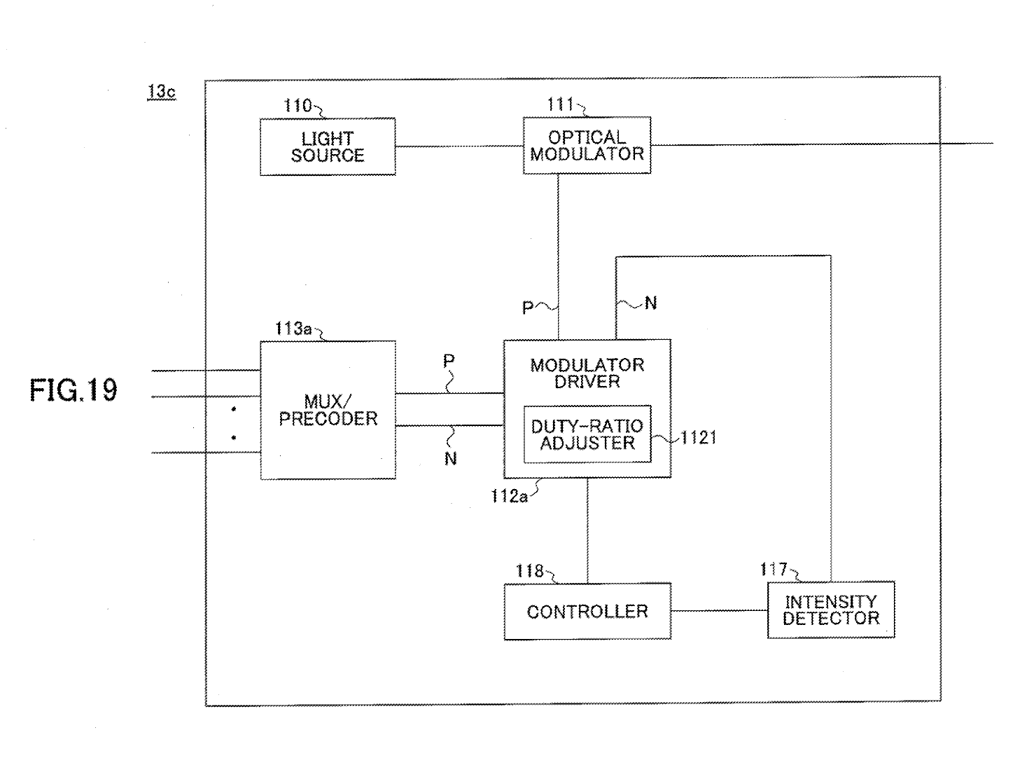

A third modified example of the optical transmitter 13 in the third embodiment is described with reference to FIG. 19. FIG. 19 is an example block diagram illustrating a configuration of an optical transmitter 13c in the third modified example of the third embodiment.

As illustrated in FIG. 19, similar to the optical transmitter 13a in the first embodiment, the optical transmitter 13c in the third modified example includes the light source 110, the optical modulator 111, the differential-type modulator driver 112a, the differential-type MUX/precoder 113a, the intensity detector 117, and the controller 118. The optical transmitter 13c in the third modified example differs from the optical transmitter 13a in the first modified example in that it is not necessary for the optical transmitter 13c to include the branching circuit 131.

Specifically, in the optical transmitter 13c in the third modified example, one of the driver output signal (positive phase:P) and the driver output signal (negative phase:N) output from the modulator driver 112a is output to the optical modulator 111. On the other hand, in the optical transmitter 13c in the third modified example, the other of the driver output signal (positive phase:P) and the driver output signal (negative phase:N) output from the modulator driver 112a is output to the intensity detector 117. In other words, in the optical transmitter 13c in the third modified example, it is not necessary to output the other of the driver output signal (positive phase:P) and the driver output signal (negative phase:N) output from the modulator driver 112a to the optical modulator 111. Namely, in the optical transmitter 13c in the third modified example, the other of the driver output signal (positive phase:P) and the driver output signal (negative phase:N) output from the modulator driver 112a is used as a dedicated signal to detect the signal intensity in the intensity detector 117.

The optical transmitter 13c in the third modified example having the configuration described above may also produce the same effects as those produced by the optical transmitter 13 according to the third embodiment described above.

Further, in the optical transmitter 13c of the third modified example, it is not necessary to branch the driver output signal having a relatively higher frequency (e.g., tens of GHz) using the branching circuit 131. Therefore, it may become possible to prevent (reduce) the signal loss caused by the branch of the driver output signal having a relatively higher frequency (e.g., tens of GHz). Therefore, it is not necessary for the optical modulator 111 to modulate the light in based on the driver output signal in which the signal loss has occurred. As a result, it may becomes possible for the optical modulator 111 to modulate the light more preferably.

### (6-4) Fourth Modified Example of Optical Transmitter in the Third Embodiment

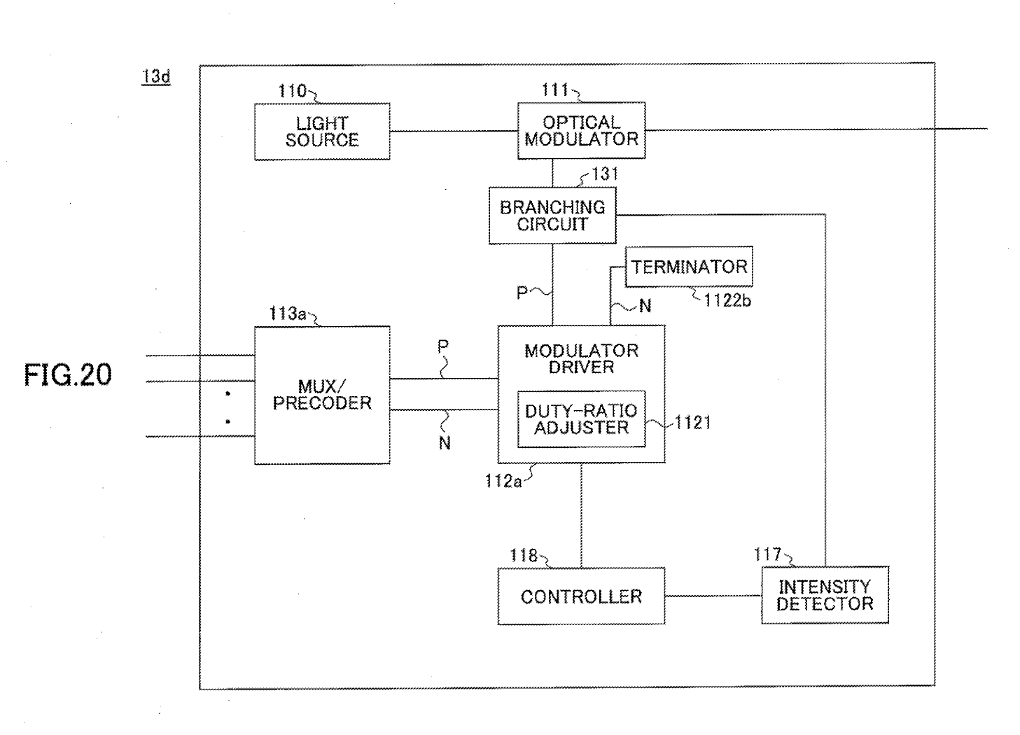

A fourth modified example of the optical transmitter 13 in the third embodiment is described with reference to FIG. 20. FIG. 20 is an example block diagram illustrating a configuration of an optical transmitter 13d in the fourth modified example of the third embodiment.

As illustrated in FIG. 20, similar to the optical transmitter 13a in the first modified example, the optical transmitter 13d in the fourth modified example includes the light source 110, the optical modulator 111, the differential-type modulator driver 112a, the differential-type MUX/precoder 113a, the intensity detector 117, the controller 118, and the branching circuit 131. The optical transmitter 13d in the fourth modified example differs from the optical transmitter 13a in the first modified example in that one of the two output terminals of the differential-type modulator driver 112a is terminated by the terminator 1122b. Namely, in the optical transmitter 13d in the fourth modified example, one of the two output terminals of the differential-type modulator driver 112a to output the driver output signal (positive phase:P) and the driver output signal (negative phase:N) is terminated by the terminator 1122b.

FIG. 20 illustrates a case where the output terminal of the differential-type modulator driver 112a to output the driver output signal (negative phase:N) is terminated by the terminator 1122b. Therefore, in this case, the branching circuit 131 branches the river output signal (positive phase:P) and the optical modulator 111 modulates the light output from the light source 110 in accordance with the driver output signal (positive phase:P).

However, alternatively, the output terminal of the differential-type modulator driver 112a to output the driver output signal (positive phase:P) may be terminated by the terminator 1122b. In this case, the branching circuit 131 branches the river output signal (positive phase:N) and the optical modulator 111 modulates the light output from the light source 110 in accordance with the driver output signal (negative phase:N).

The optical transmitter 13d in the fourth modified example having the configuration described above may also produce the same effects as those produced by the optical transmitter 13 according to the third embodiment described above.

### (6-5) Fifth Modified Example of Optical Transmitter in the Third Embodiment

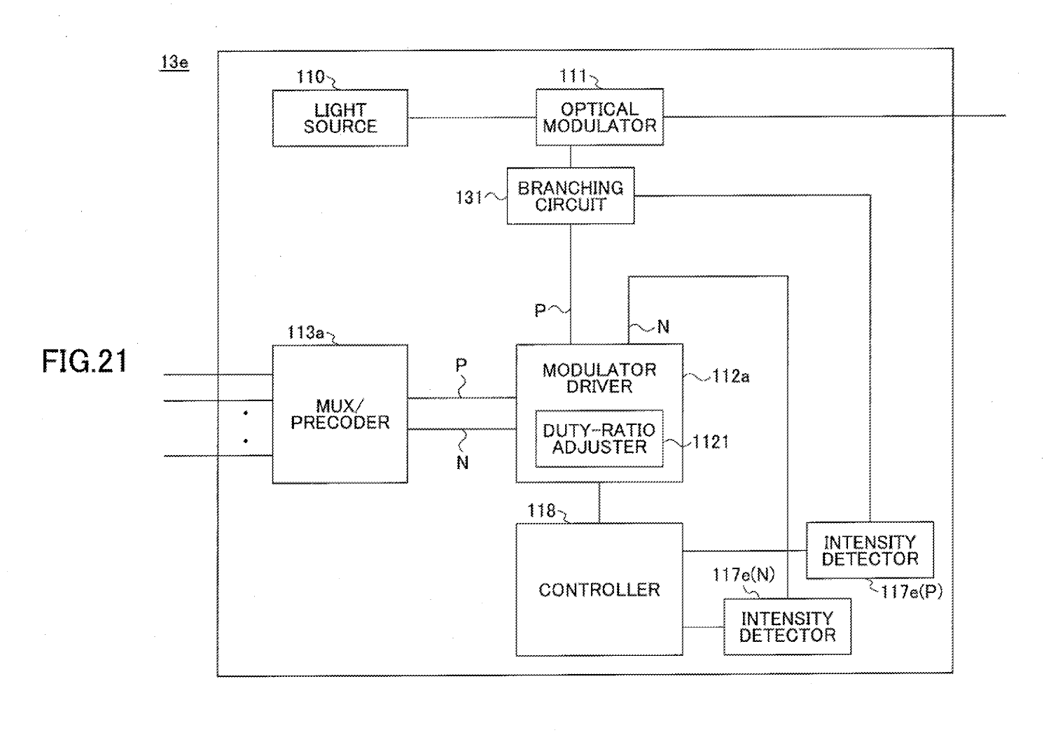

A fifth modified example of the optical transmitter 13 in the third embodiment is described with reference to FIG. 21. FIG. 21 is an example block diagram illustrating a configuration of an optical transmitter 13e in the fifth modified example of the third embodiment.

As illustrated in FIG. 21, similar to the optical transmitter 13a in the first modified example, the optical transmitter 13e in the fifth modified example includes the light source 110, the optical modulator 111, the differential-type modulator driver 112a, the differential-type MUX/precoder 113a, the intensity detector 117, the controller 118, and the branching circuit 131. The optical transmitter 13e in the fifth modified example differs from the optical transmitter 13a in the first modified example in that the optical transmitter 13b includes two intensity detectors 117. Further, the optical transmitter 13e in the fifth modified example differs from the optical transmitter 13a in the first modified example in that one of the driver output signal (positive phase:P) and the driver output signal (negative phase:N) is output to the optical modulator 111, and it is not necessary for the other of the driver output signal (positive phase:P) and the driver output signal (negative phase:N) to be output to the optical modulator 111.

Further, specifically, the optical transmitter 13e in the fifth modified example includes an intensity detector 117e(P) and an intensity detector 117e(N). The intensity detector 117e(P) detects the signal intensity of the driver output signal (positive phase:P) branched by the branching circuit 131. The intensity detector 117e(N) detects the signal intensity of the driver output signal (negative phase:N) output from the differential-type modulator driver 112a. Further, it is not necessary to output the driver output signal (negative phase:N) to the optical modulator 111, the driver output signal (negative phase:N) being output from the from the differential-type modulator driver 112a to the intensity detector 117e(N).

The controller 118 adjusts the duty ratio of the driver output signal in accordance with the signal intensity of the driver output signal (positive phase:P) detected by the intensity detector 117e(P) or the signal intensity of the driver output signal (positive phase:N) detected by the intensity detector 117e(N), or both.

The optical transmitter 13e in the fifth modified example having the configuration described above may also produce the same effects as those produced by the optical transmitter 13 according to the third embodiment described above.

Further, in the optical transmitter 13e of the fifth modified example, even when one of the signal quality of the driver output signal (positive phase:P) and the signal quality of the driver output signal (positive phase:N) is degraded, it may become possible to adjust the duty ratio of the driver output signal in accordance with the other of the signal quality of the driver output signal (positive phase:P) and the signal quality of the driver output signal (positive phase:N). By having this feature, it may become possible to ensure the redundancy of the driver output signal to be referred to to adjust the duty ratio of the driver output signal. As a result, it may become possible to relatively enhance the reliability of the adjusting operation of adjusting the duty ratio of the driver output signal.

### (7) Optical Transmitter According to a Fourth Embodiment of the Present Invention

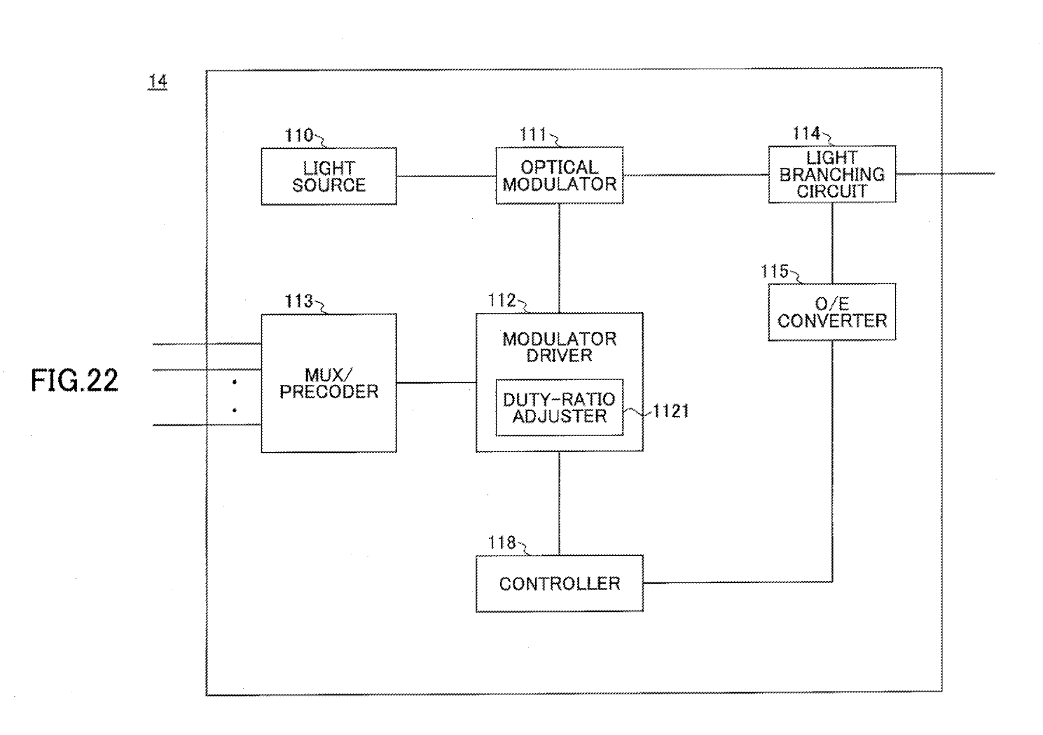

An optical transmitter 14 according to the fourth embodiment of the present invention is described with reference to FIGS. 22 to 26. The same reference numerals and the same operation numbers are used to describe the same elements and the same processes as those in the configurations of the optical transmitter 11 in the first embodiment, the optical transmitter 11a in the first modified example, the optical transmitter 11b in the second modified example, the optical transmitter 11c in the third modified example, and the optical transmitter 12 in the second embodiment, the optical transmitter 13 in the third embodiment, the optical transmitter 13a in the first modified example, the optical transmitter 13b in the second modified example, the optical transmitter 13c in the third modified example, the optical transmitter 13d in the fourth modified example, and the optical transmitter 13e in the fifth modified example, and the detailed descriptions thereof may be omitted. Further, as described above, FIG. 1 illustrates the optical transmission system 1 including the optical transmitters 11. However, alternatively, the optical transmission system 1 may includes the optical transmitters 14 instead of the optical transmitters 11. Otherwise, the optical transmission system 1 may includes both the optical transmitter 11 along with the optical transmitter 14.

### (7-1) Configuration of Optical Transmitter According to the Forth Embodiment of the Present Invention

An example configuration of the optical transmitter 14 according to the fourth embodiment of the present invention is described with reference to FIG. 22. FIG. 22 is an example block diagram of a configuration of the optical transmitter 14 according to the fourth embodiment of the present invention.

As illustrated in FIG. 22, similar to the optical transmitter 11 in the first embodiment, the optical transmitter 14 in the fourth embodiment includes the light source 110, the optical modulator 111, the modulator driver 112, the MUX/precoder 113, the light branching circuit 114, the O/E (Optical/Electronic) converter 115, and the controller 118. The optical transmitter 14 in the fourth embodiment differs from the optical transmitter 11 in the first embodiment in that it is not necessary for the optical transmitter 14 in the fourth embodiment to include the signal component detector 116 and the intensity detector 117.

Further, in the optical transmitter 14 in the fourth embodiment, the O/E converter 115 detects the signal intensity of the light modulation signal (e.g., average light power). The O/E converter 115 outputs the detected signal intensity of the light modulation signal to the controller 118.

In the optical transmitter 14 in the fourth embodiment, the controller 118 controls the duty ratio of the driver output signal in accordance with the signal intensity of the light modulation signal detected by the O/E converter 115. More specifically, the controller 118 controls the duty ratio of the driver output signal in a manner so as to, for example, maximize the signal intensity of the light modulation signal.

### (7-2) Operations of Optical Transmitter According to the Fourth Embodiment of the Present Invention

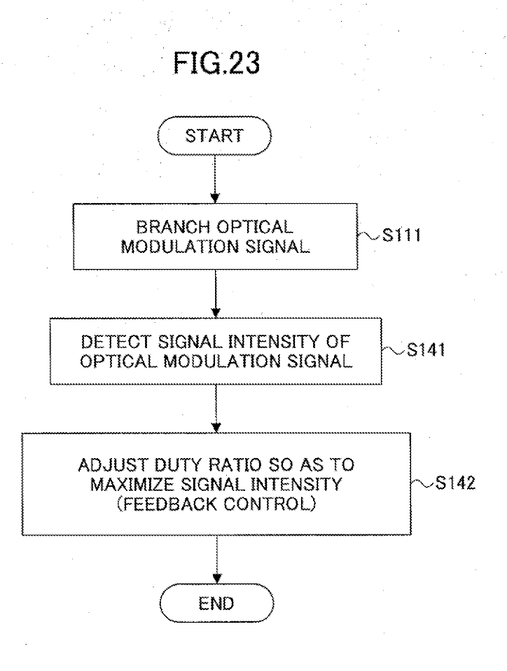

Operations of the optical transmitter 14 according to the fourth embodiment of the present invention are described with reference to FIG. 23. FIG. 23 is an example flowchart illustrating an operational procedure of the optical transmitter 14 according to the fourth embodiment of the present invention. Further, in the following, the description is focused on an adjusting operation of adjusting the duty ratio of the driver output signal from among the operations of the optical transmitter 14 according to the fourth embodiment of the present invention.

As illustrated in FIG. 23, the light branching circuit 114 branches the optical modulation signal output from the optical modulator 111 (operation S111). The light branching circuit 114 outputs the branched optical modulation signal to the O/E converter 115.

Then, the O/E converter 115 detects the signal intensity of the light modulation signal (e.g., average light power) (operation S141). The O/E converter 115 outputs the detected signal intensity of the light modulation signal to the controller 118.

Then, the controller 118 adjusts the duty ratio of the driver output signal so as to maximize the signal intensity of the light modulation signal detected by the O/E converter 115 (operation S142). Specifically, for example, the controller 118 adjusts the duty ratio of the driver output signal in a manner such that the signal intensity of the light modulation signal after the adjustment of the duty ratio is greater than the signal intensity of the light modulation signal before the adjustment of the duty ratio (i.e., the signal intensity of light modulation signal detected by the O/E converter 115).

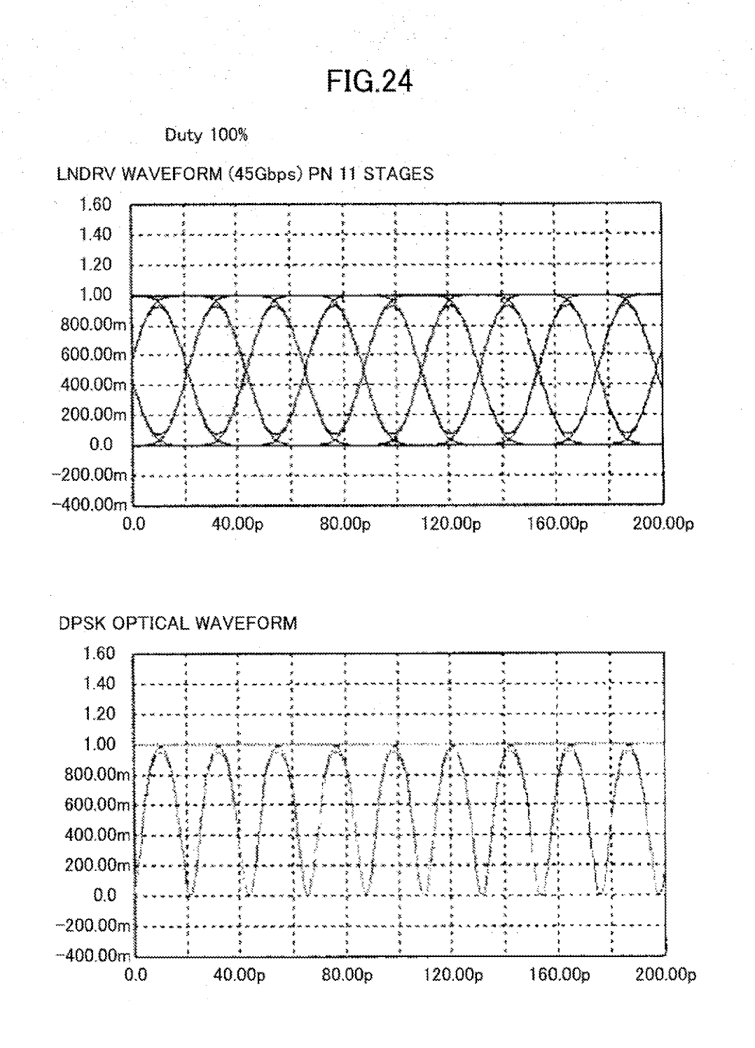

Herein, a technical meaning of the adjustment of the duty ratio of the driver output signal so as to maximize the signal intensity of the light modulation signal is described with reference to FIGS. 24 to 26. FIGS. 24 to 26 are graphs illustrating waveforms of the driver output signal and the light modulation signal when the duty ratio of the driver output signal is changed.

FIG. 24 illustrates the waveform of the driver output signal (LNDRV waveform 45 Gbps) and the waveform of the light modulation signal (DPSK optical waveform) when the duty ratio of the driver output signal is 100%.

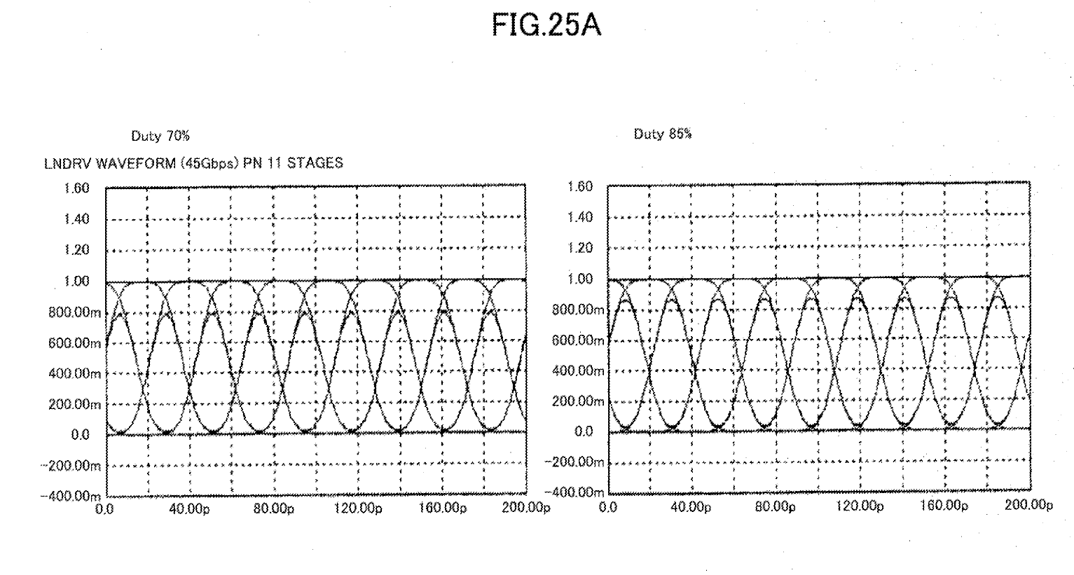

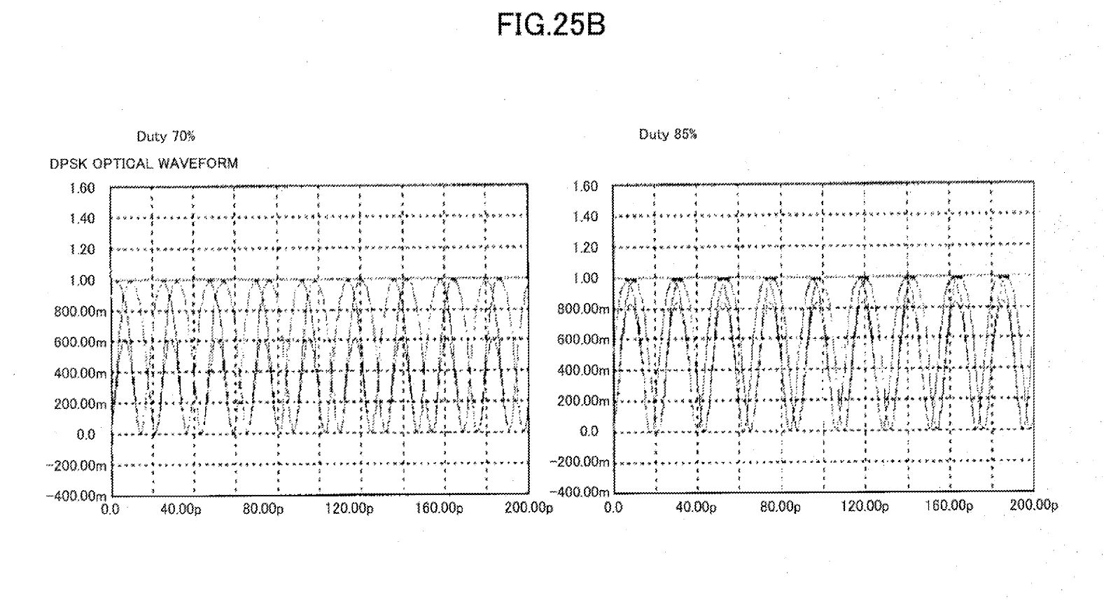

On the other hand, FIGS. 25A and 25B illustrate the waveform of the driver output signal (LNDRV waveform 45 Gbps) and the waveform of the light modulation signal (DPSK optical waveform) when the duty ratio of the driver output signal is less than 100%. As the cases where the duty ratio of the driver output signal is less than 100%, FIGS. 25A and 25B illustrate a case where a duty ratio of the driver output signal is 70% and a case where a duty ratio of the driver output signal is 85%. As illustrated in FIGS. 25A and 25B, in a case where the duty ratio of the driver output signal is less than 100%, when compared with the case where the duty ratio of the driver output signal is 100%, the waveforms of the driver output signal and the optical modulation signal are less stuck to the high level side (middle upper side of FIG. 25B). When the waveforms of the driver output signal and the optical modulation signal are less stuck to the high level side (middle upper side of FIG. 25B), the signal intensity (e.g., the average light power) of the light modulation signal may accordingly be reduced. Such a phenomenon may easily cause the degradation of the OSNR when compared with the case where the duty ratio of the driver output signal is 100%.

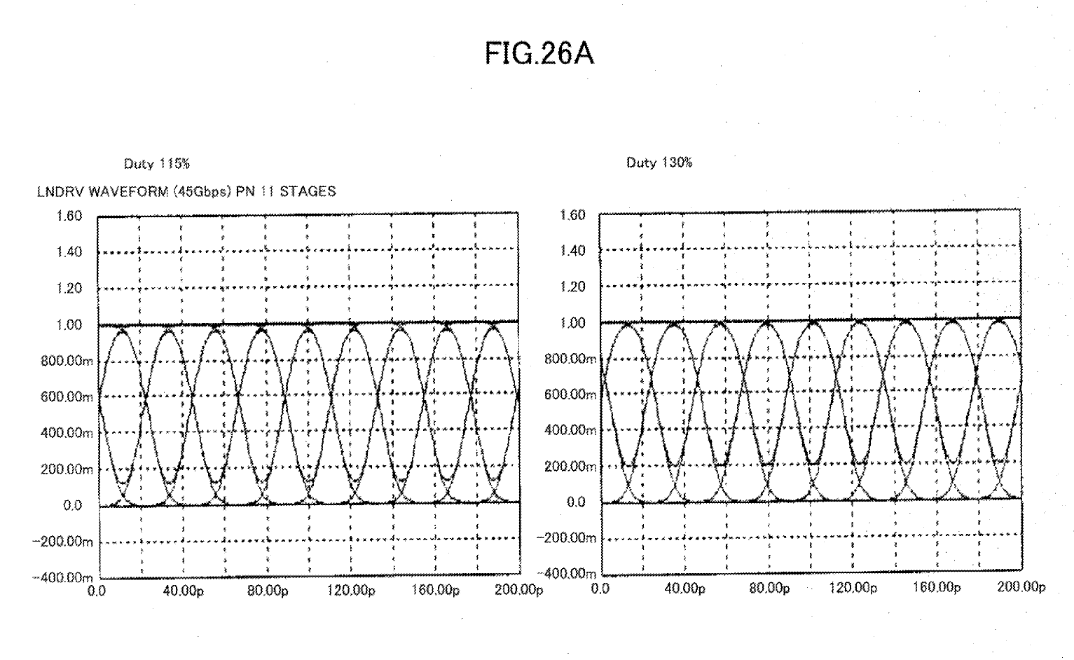

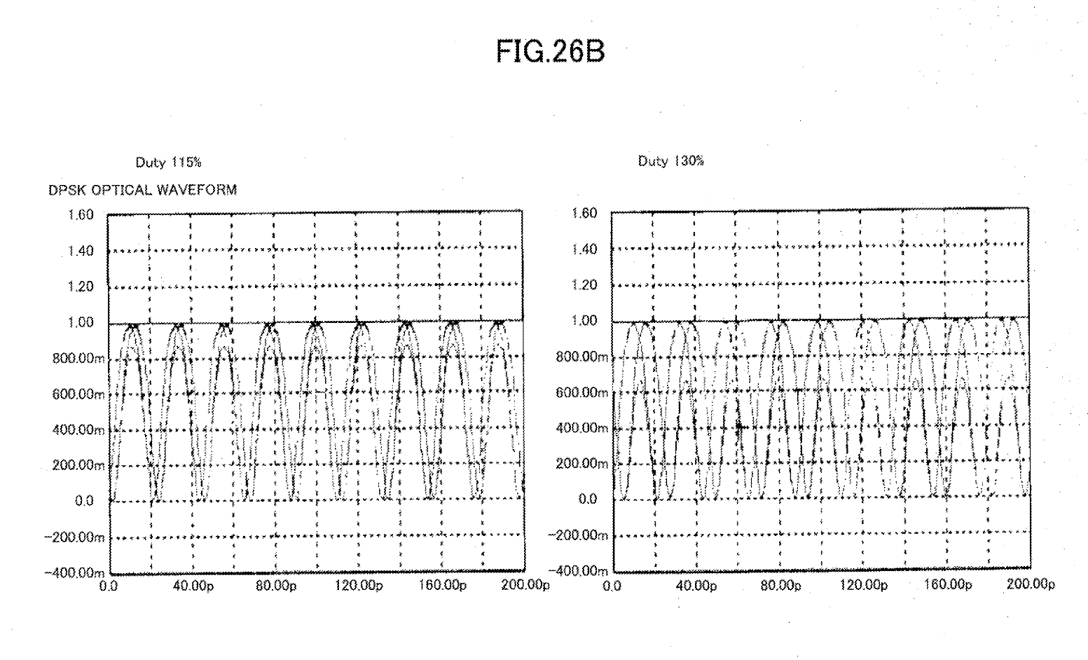

On the other hand, FIGS. 26A and 26B illustrate the waveform of the driver output signal (LNDRV waveform 45 Gbps) and the waveform of the light modulation signal (DPSK optical waveform) when the duty ratio of the driver output signal is greater than 100%. As the cases where the duty ratio of the driver output signal is greater than 100%, FIGS. 26A and 26B illustrate a case where a duty ratio of the driver output signal is 115% and a case where a duty ratio of the driver output signal is 130%. As illustrated in FIGS. 26A and 26B, in a case where the duty ratio of the driver output signal is greater than 100%, when compared with the case where the duty ratio of the driver output signal is 100%, the waveforms of the driver output signal and the optical modulation signal are less stuck to the high level side (middle upper side of FIG. 26B). When the waveforms of the driver output signal and the optical modulation signal are less stuck to the high level side (middle upper side of FIG. 26B), the signal intensity (e.g., the average light power) of the light modulation signal may accordingly be reduced. Such a phenomenon may easily cause the degradation of the OSNR when compared with the case where the duty ratio of the driver output signal is 100%.

In consideration of the relationships between the change of the duty ratio of the driver output signal and the change of the signal intensity of the light modulation signal and the driver output signal, the optical transmitter 14 according to the fourth embodiment of the present invention is configured to control the duty ratio of the driver output signal so as to maximize the signal intensity of the light modulation signal. By doing this, it may become possible to substantially or completely eliminate a possibility that the duty ratio of the driver output signal is far from 100%. In other words, substantially, it may become possible to maintain the duty ratio of the driver output signal at or near 100%. Therefore, in the optical transmitter 14 according to the fourth embodiment of the present invention, it may become possible to drive the optical modulator 111 so as to control (prevent) the degradation of the quality of the optical modulation signal (i.e., the degradation of the OSNR). Namely, the optical transmitter 14 in the fourth embodiment of the present invention having the configuration described above may also produce the same effects as those produced by the optical transmitter 11 according to the first embodiment of the present invention.

### (8) Modified Example of Optical Transmitter in the Fourth Embodiment

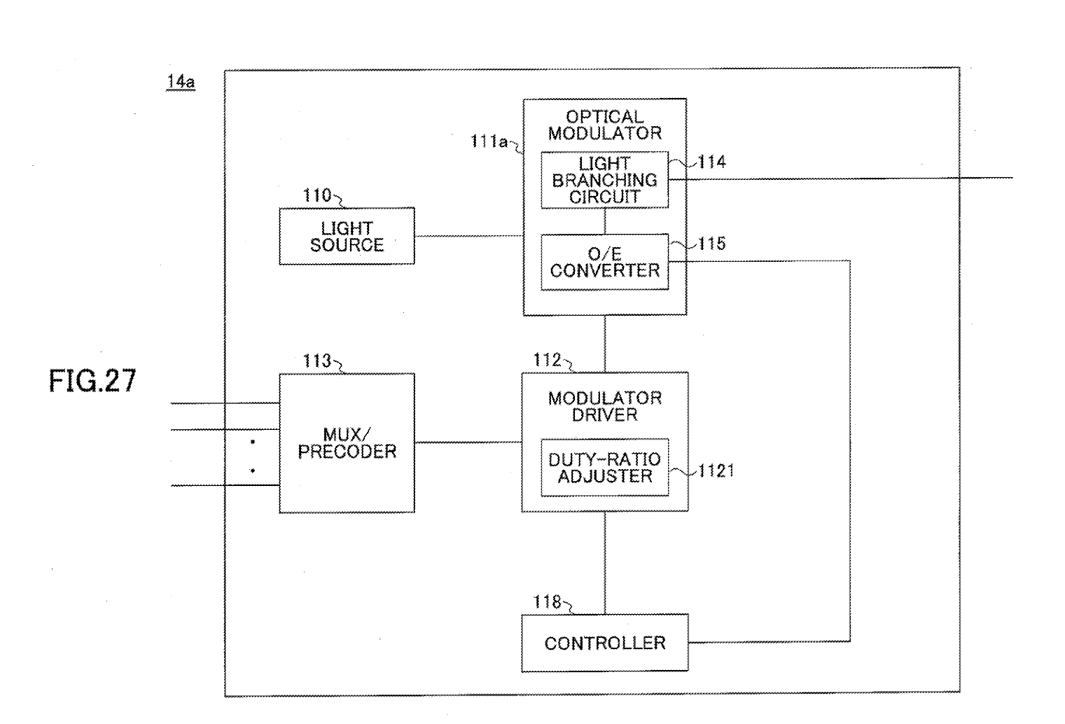

A modified example of the optical transmitter 14 in the fourth embodiment is described with reference to FIG. 27. FIG. 27 is an example block diagram illustrating a configuration of an optical transmitter 14a in the modified example of the fourth embodiment.

As illustrated in FIG. 27, similar to the optical transmitter 14 in the fourth embodiment, the optical transmitter 14a in the modified example of the fourth embodiment includes the light source 110, an optical modulator 111a, the modulator driver 112, the MUX/precoder 113, the light branching circuit 114, the O/E converter 115, and the controller 118. The optical transmitter 14a in the modified example differs from the optical transmitter 14 in the fourth embodiment in that the light branching circuit 114 and the O/E converter 115 are included in the optical modulator 111a.

The optical transmitter 14a in the modified example having the configuration described above may also produce the same effects as those produced by the optical transmitter 14 according to the fourth embodiment of the present invention.

In the above description, cases are described where the duty ratio of the driver output signal is adjusted in accordance with the signal intensity of the f0 component of the light modulation signal (i.e., the f0 component of the electric signal converted from the light modulation signal) or the signal intensity of the driver output signal or the light modulation signal. However, alternatively, for example, the duty ratio of the driver output signal may be adjusted in accordance with any other parameter (e.g., any of the parameters related to the phase, the frequency and the like) of the light modulation signal and the driver output signal.

Further, in the above description, cases are described where the duty ratio of the driver output signal is adjusted. However, alternatively, for example, any of the parameters (e.g., a peak pulse, a bottom pulse, a pulse width, a phase, a frequency, and the like) related to the waveform of the driver output signal may be adjusted.

Further, any of the configurations of the optical transmitter 11 according to the first embodiment (along with the optical transmitters in various modified examples), optical transmitter 12 according to the second embodiment (along with the optical transmitters in various modified examples), optical transmitter 13 according to the third embodiment (along with the optical transmitters in various modified examples), and optical transmitter 14 according to the fourth embodiment (along with the optical transmitters in various modified examples) may be appropriately combined.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present inventions has been described in detail, it is to be understood that various changes, substitutions, and alterations could be made hereto without departing from the spirit and scope of the invention.

What is claimed is:

1. An optical transmitter comprising:
a driver that outputs data;
an optical modulator that outputs an optical modulation signal by modulating light from a light source based on the data output from the driver;
a detector that detects at least one of a signal intensity of the optical modulation signal from the optical modulator and a signal intensity of the data from the driver and outputs a detection result; and
an adjustor that adjusts a signal parameter of the data based on the detection result.

2. The optical transmitter according to claim 1,
wherein the detector is configured to detect a signal intensity of a frequency component of the optical modulation signal, the frequency component corresponding to a bit rate of the optical transmitter.

3. The optical transmitter according to claim 1,
wherein the detector is configured to detect a signal intensity of a frequency component of an electric signal, the electric signal being converted from the optical modulation signal, the frequency component corresponding to a bit rate of the optical transmitter.

4. The optical transmitter according to claim 2,
wherein the adjustor is configured to adjust the signal parameter of the data so as to maximize the signal intensity.

5. The optical transmitter according to claim 4,
wherein the optical modulator is configured to modulate the light using a DPSK (Differential Phase Shift Keying) scheme.

6. The optical transmitter according to claim 2,
wherein the adjustor is configured to adjust the signal parameter of the data so as to minimize the signal intensity.

7. The optical transmitter according to claim 6,
wherein the optical modulator is configured to modulate the light using an NRZ (Non Return to Zero) scheme.

8. The optical transmitter according to claim 1,
wherein the detector is configured to detect the signal intensity of the data,
wherein the adjustor is configured to adjust the signal parameter so that the signal intensity is equal to a predetermined value,
wherein the predetermined value represents an average intensity of the data when a duty ratio is 100%, and
wherein the duty ratio is a ratio between a signal component of the data when the signal intensity is equal to or greater than the predetermined value and a signal component of the data when the signal intensity is less than the predetermined value.

9. The optical transmitter according to claim 1,
wherein the detector is configured to detect the signal intensity of the data,
wherein the adjustor is configured to adjust the signal parameter so that the signal intensity is a predetermined value,
wherein the driver includes a differential-type driver generating differential-type data as the data based on a differential signal, and
wherein the driver is configured to output one of the differential-type data to the optical modulator and outputs the other of the differential-type data to the detector.

10. The optical transmitter according to claim 1,
wherein the detector is configured to detect the signal intensity of the optical modulation signal, and
wherein the adjustor is configured to adjust the signal parameter of the data so as to maximize the signal intensity.

11. The optical transmitter according to claim 1,
wherein the signal parameter includes a duty ratio between a signal component of the data when the signal intensity is equal to or greater than a predetermined value and a signal component of the data when the signal intensity is less than the predetermined value.

12. An optical transmission device comprising:
the optical modulator according to claim 1;
an optical transmission path; and
an opposing device;
wherein the optical modulation signal output from the optical modulator is transmitted to the opposing device via the optical transmission path.

13. A method of controlling an optical transmitter, the method comprising:
detecting at least one of the optical modulation signals output from an optical modulator of an optical transmitter and the data output from a driver of the optical transmitter; and
adjusting a signal parameter of the data based on a result of the detecting.
